(19) United States
(12) Patent Application Publication
(10) Pub. No.: US 2025/0173861 A1
(43) Pub. Date: May 29, 2025

(54) A METHOD OF DETECTION OF A LANDMARK IN A VOLUME OF MEDICAL IMAGES

(71) Applicant: HEMOLENS DIAGNOSTICS SPÓLKA Z OGRANICZONA ODPOWIEDZIALNOSCIA, Wroclaw (PL)

(72) Inventors: Tomasz KONOPCZYNSKI, Wroclaw (PL); Patryk RYGIEL, Wroclaw (PL); Milosz GAJOWCZYK, Prudnik (PL); Piotr GRÓDEK, Wroclaw (PL); Lukasz MOROZ, Nowogród Bobrzanski (PL); Bartlomiej CUPIAL, Gliwice (PL)

(21) Appl. No.: 18/843,172

(22) PCT Filed: Mar. 1, 2022
(86) PCT No.: PCT/IB2022/051785

§ 371 Date: Aug. 30, 2024

(51) Int. Cl. G06T 7/00; G06T 7/70

(52) U.S. Cl. CPC G06T 7/0012; G06T 7/70; G06T 2207/10081; G06T 2207/10088; G06T 2207/20081; G06T 2207/30101

(57) ABSTRACT

Detection of landmarks in volumes of medical images is an important step in developing various diagnostic procedures. The invention pertains to a method detection of a landmark in a volume of medical images. Said volume of medical images can be selected from a computational tomography volume or a magnetic resonance volume. The invention includes a residual U-Net architecture to produce a heatmap that describes probability of finding the landmark which can be combined with a 3D Differentiable Spatial to Numerical Transform (DSNT) in order to obtain coordinates of the landmark. The invention was evaluated on two datasets: dataset containing 157 Coronary Computed Tomography Angiography (CCTA) scans and a dataset containing 77 Computed Tomography Angiography (CTA) scans. The proposed method provides a significantly improve accuracy of landmark detection, especially for ostium landmark detection, when compared to known methods.

### FIELD OF THE INVENTION

The present invention pertains to detection of landmarks in medical images, such as computational tomography (CT) volumes and magnetic resonance (MR) image volumes. Landmarks include in particular coronary ostia. Detection is done using a deep learning model including neural network. Specifically, residual U-Net architecture. Transformation of probability to coordinates is done using non-trainable 3D Differentiable Spatial to Numerical Transform (DSNT).

### BACKGROUND

An automatic ostia detection is used in various medical image analysis techniques. It is often paired with other tasks such as an image segmentation or a registration. The main challenges in automatic ostia detection are anatomical differences between patients and differences in image acquisition. Regression of landmarks' coordinates is done globally and does not require a local refinement whereas other most common techniques do [4, 17, 18, 26, 31], especially to achieve the state of the art (SOTA) performance of a median Euclidean distance error equal to 1.12 mm and 1.05 mm for the left ostium and for the right ostium, respectively.

The first methods which tackled the problem of coronary ostia detection from a Coronary Computed Tomography Angiography (CCTA) are based on finding intensity patterns. Both Waechter et al. [26] and Elattar et al. [4] use a prior aortic valve segmentation to perform an intensity-based landmark detection on the surface of the aorta. Elattar et al. achieved a Euclidean error of 2.81±2.07 mm. These methods were strictly designed to detect coronary ostia and required a two-step setup to perform the detection. The required two-step setup was time-consuming and the methods were not time-efficient. Moreover, the accuracy of these methods is limited by anatomical anomalies and said anatomical differences between patients.

The introduction of machine learning was beneficial both for robustness and for time consumption. Classical machine learning methods can be divided into two types: a classification-based [2, 3, 7, 8, 12, 13, 19, 25, 31] and a regression-based [1, 3, 5, 6, 19, 22, 25] methods. The classification-based methods are producing a probability for a given pixel/voxel to be a landmark of interest. For the application in the coronary ostia detection, Ionasec et al. [8] proposed to use probabilistic boosting trees to achieve a Euclidean error of 2.28 mm. Zheng et al. [31] used global-to-local marginal space learning and obtained a Euclidean error of 2.11±1.34 mm.

The regression-based methods are designed to output a continuous value that defines sub-resolution coordinates for a landmark of interest. Al et al. [1] employed an approach based on colonial walks to the problem of coronary ostia detection and achieved a Euclidean error of 2.01±1.04 mm. Due to the recent growth in the area of artificial neural networks, many Deep Neural Network (DNN) based approaches to the problem of landmark detection were introduced. The first networks which tackled the problem of landmark detection employed a Convolutional Neural Network (CNN) model with a fully-connected head to regress landmark coordinates [9, 24]. Mostafa et al. [14] proposes to use a U-Net architecture with a fully-connected head to solve the problem of coronary ostia detection. They report 68.3% and 74.1% SDR (success detection rate), respectively, for the threshold of 2 mm.

Using heatmap matching as another approach has been introduced in subsequent work [23]. In this approach, a landmark is represented as a Gaussian centered at its coordinates. The model comprised in this approach produces heatmaps which are supposed to match Gaussian landmark representations and are penalized by the mean square error (MSE) loss. This landmark representation is similar to classification-based ML (ML—machine learning) methods where a probability of a landmark presence at its position is predicted for each pixel/voxel. A current SOTA performance level regarding landmark detection is achieved by models based on the pyramid/hourglass architecture [15, 28]. Heatmap matching was also used for medical images by Payer et al. [20] to perform a landmark detection on X-ray images. Wolterink et al. [27] used it in coronary ostia detection and obtained a Euclidean error of 1.8±1.0 mm for a test set of 36 images.

The current best-performing methods of coronary ostia detection employ a two-step hybrid approach. Noothout et al. developed in 2018 an approach that performed a slice-wise image analysis [18]. This approach comprises a vector pointing from the center of each slice to a landmark of interest. The vector is regressed for said each slice and the probability of a given landmark presence on the given slice is predicted. A CNN was implemented for this task with two heads and the final landmark location was found by weighing a prediction vector by a predicted presence probability. The backbone of the CNN was responsible for finding rough landmark locations which were subsequently individually refined by a subsequent network of the same design as the main network. They reported a Euclidean error of 2.19 and 2.88 mm for the right and left coronary ostium, respectively, for a test set of 40 CCTA volumes. Noothout's approach was further refined by its creators and expanded in 2020 by Noothout et al [17]. The slice-wise approach was changed to the patch-wise approach and a CCTA dataset was further expanded to 672 volumes with 200 volumes comprised in a test set. With a larger dataset and a greater anatomical variability, they achieved a median (IQR—interquartile range) Euclidean error of 1.45 (1.20) and 1.55 (0.97) mm for the right and the left coronary ostium, respectively. However, such results were only achieved by using a subsequent local refinement network. The lowest median (IQR) Euclidean error achieved with the use of a global network only was reported to be 2.90 (1.93) 3.31 (2.23) mm for the right and the left coronary ostium, respectively.

This review of prior art developments is underlying that there is a need for a reliable and precise method that will allow to find landmark coordinates fast. The present invention addresses this need.

### BRIEF DESCRIPTION OF THE INVENTION

The forthcoming description is to better understand the principle and benefits of the invention claimed in the appended claims. Therefore, it is not meant to be limiting in any sense. In particular, certain explanations to the meaning or to the function of, for example, equations used within the invention cannot be understood as limiting or exhaustive. They are provided to facilitate understanding and cannot replace the full understanding provided by a common general knowledge of a skilled person in this field.

The invention pertains to a problem of landmark detection, in particular to automatic ostia detection. The invention implements learning a supervised regression model of landmark coordinates from, for example, a computational tomography (CT) volume and from human annotations. Term supervised has a typical definition used in this filed and refers to use of examples to teach the algorithm.

We refer to input volume as x, human annotations as y and model predictions as y. Within the scope of this disclosure, bolded symbols used in equations refer to vectors and not bolded symbols refer to scalars.

The invention includes a heatmap matching regression which can be combined with extraction of heatmap center coordinates by a Differentiable Spatial to Numerical Transform (DSNT) layer. The invention can involve a combination of residual U-Net with 3D DSNT for landmark detection. In particular, for coronary ostia detection.

For simplification of the description, residual blocks can be used interchangeably with blocks. For example, encoding residual block can also be called encoding block. Volumes are results of medical scans. For example, a computational tomography volume is a result of a CT scan

In one aspect, the invention pertains to a method of localization of a landmark in a volume of medical images. The method comprises generating at least one heatmap using a trained residual U-Net applied on the volume of medical images. For the method, the volume of medical images consists of a computational tomography volume or a magnetic resonance volume. The volume of medical images comprises voxels. The method can be realized as a computer-implemented invention. Localization can include, but is not limited to, indicating of probable position on a heatmap, providing coordinates of a landmark, providing estimated coordinates of a landmark or providing a range of coordinates in which a landmark is located. The range of coordinates can be a range for only one coordinate, two or three coordinates.

Said at least one heatmap according to the invention is produced using a trained residual U-Net applied on the volume of medical images. Each said heatmap represents a probability of finding localization of said at least one landmark in voxels.

The residual U-Net of the invention comprises a contracting path and an expansive path. The contracting path comprises residual encoding blocks for encoding the volume of medical images. The expansive path comprises residual decoding blocks for decoding the volume of medical images encoded by the contracting path.

The method of the present invention, when compared to known methods, provides localization of landmarks fast and with significantly improved accuracy. Furthermore, the method, when trained, becomes a one-step method which is relevant from the standpoint of view of application of the method in medical practice.

In one embodiment, the method additionally involves transforming said at least one heatmap to coordinates of at least one landmark using a 3D Differentiable Spatial to Numerical Transform. This embodiment performs even better when compared to the method using only a residual U-Net.

In one embodiment, each said heatmap is normalized. Normalization makes the method less computationally demanding.

In one embodiment, the volume of medical images is a pre-processed volume of medical images. Pre-processing can be different for training and for using the method of the invention. For example, the re-processed volume of medical images is obtained using at least one of central cropping, clipping and setting values of selected voxels to defined values, normalizing the values of voxels, downsizing the volume of medical images and augmenting. Pre-processing is done to remove unnecessary information to make the method less computationally demanding.

Said clipping and setting values of selected voxels to defined values can comprise setting values of voxels smaller than −300 HU to −300 HU and setting values of voxels higher than 1100 HU to 1100 HU.

Said normalizing the values of voxels can include setting values of voxels equal −300 HU to 0, setting values of voxels equal 1100 HU to 1, and scaling linearly values between −300 HU and 1100 HU are set to a corresponding value in the scale from 0 to 1.

Said downsizing can include decreasing the volume of the volume of medical images 3 to 4 times. In particular, downsizing includes decreasing the volume of the volume of medical images 3.1, 3.2, 3.3, 3.4, 3.5, 3.6, 3.7, 3.8 or 3.9 times.

The augmenting can include rotation up to π/6 radians and translation up to 10 voxels in each dimension.

In one embodiment, encoding comprises downsampling of the volume of medical images and increasing the number of channels to produce a downsampled output and sending the downsampled output to a corresponding encoding residual block and to a corresponding decoding residual block.

In one embodiment, said downsampling is done by a factor of two.

In another embodiment, said decoding comprises upsampling of an input to a residual decoding block of the volume of medical images to produce an upsampled output with a decreased number of channels. The upsampling can done by a factor of two.

In one embodiment, training of the trained residual U-Net comprises at least one of:
minimization of the divergence between said at least one heatmap and an annotated heatmap comprising at least one annotation, wherein said at least annotation points to localization of the landmark on said at least one heatmap, and
minimization of the Euclidean distance between the localization on said at least one heatmap and the localization on the heatmap comprising at least one annotation.

In one embodiment, training of the trained residual U-Net comprises both minimization of the divergence between said at least one heatmap and an annotated heatmap comprising at least one annotation, wherein said at least annotation points to localization of the landmark on said at least one heatmap, and minimization of the Euclidean distance between the localization on said at least one heatmap and the localization on the heatmap comprising at least one annotation. Training involving both minimizations allows for obtaining the most precise results.

In embodiments, the probability of finding the landmark has a normal distribution.

In an embodiment, said minimization of the Euclidean distance includes [symbol] _{E}(ŷ,y)=∥ŷ−y∥₂ and said minimization of the divergence includes [symbol] _{D}(Ĥ,y)=D_{JS}(Ĥ∥ [symbol] (y,σ²)), D_{JS}(·∥·) is the Jensen-Shannon divergence.

In embodiments, the training of the trained residual U-Net includes a linear combination of said minimization of the divergence and said minimization of the Euclidean distance.

In embodiments, said at least one heatmap and said annotated heatmap are produced using the same volume of medical images.

In embodiments, the 3D Differentiable Spatial to Numerical Transform includes:

DSNT(Ĥ)=[ [symbol] Ĥ,X [symbol] _{F}, [symbol] Ĥ,Y [symbol] _{F}, [symbol] Ĥ,Z [symbol] _{F}],

where Ĥ=φ(H), and Ĥ is the heatmap H output from the residual U-Net and normalized by a normalization function, wherein <·, ·>_{F} represents a Frobenius inner product of two matrices, wherein said two matrices are selected from Ĥ, X, Y and Z.
X, Y and Z are grids in the form of m×n×l matrices defined as:

$${X}_{i , j , k} = \frac{2 j - ( n + 1 )}{n} , {Y}_{i , j , k} = \frac{2 i - ( m + 1 )}{m} , {Z}_{i , j , k} = \frac{2 k - ( l + 1 )}{l} .$$

This 3D DSNT outperforms known methods for landmark detection, especially for coronary ostia landmarks.

In embodiments, each residual block comprises:

$${y}_{l} = h ( {x}_{l} ) + F ( {x}_{l} , {W}_{l} ) ,$$

$${x}_{l + 1} = f ( {y}_{l} )$$

where xₗ and Xₗ₊₁ are the input and output of the l-th residual block, [symbol] (·) is a residual function, ƒ(yᵢ) is an activation function and h(xᵢ) is an identity mapping function.

In embodiment, said at least one landmark is selected from the list comprising:

inlets and outlets surrounding ostium of Left Coronary Artery, inlets and outlets surrounding ostium of Right Coronary Artery, apex of left ventricle, base/basis of left ventricle, 17 segments of left ventricle according to American Heart Association, junction points of left and right ventricles, ostium LCA ostium of Left Coronary Artery, ostium RCA ostium of Right Coronary Artery, LM division of Left Main Coronary Artery, DG1 origin of 1st diagonal artery, DG2 origin of 2st diagonal artery origin of ramus intermedius artery, OM1 origin of 1st obtuse marginal artery, OM2 origin of 2st obtuse marginal artery, RCA origin of Right Coronary Artery, AM origin of Acute Marginal Branch, PDA origin of Posterior Descending Artery, PL origin of Posterior Left Ventricular Artery, inlet of Superior Vena Cava to right atrium, inlet of Inferior Vena Cava to right atrium, inlet of coronary sinus to right atrium, inlet of right appendage/auricle to right atrium, apex of right appendage/auricle, inlet of left superior/inferior and right superior/inferior pulmonary veins to left atrium, inlet of right appendage/auricle to right atrium, apex of left appendage/auricle, origin of pulmonary trunk, tricuspid valve including leaflets: anterior, posterior and septal, apex of Right Ventricle, origin of ascending aorta, aortic valve including leaflets: right, left, posterior anterior, right anterior, right posterior, anterior coronary, left coronary, right coronary, non-coronary, bicuspid valve including leaflets: anterior and posterior, mitral valve including leaflets: anterior and posterior, ANTETIOR CEREBRAL ARTERY, landmarks located at the beginning of horizontal or pre-communicating segment, vertical, post-communicating or infracallosal segment, precallosal segment, supracallosal segment, postcallosal segment, ANTERIOR COMMUNICATING ARTERY, SUPERIOR CEREBELLAR ARTERY, ANTERIOR INFERIOR CEREBELLAR ARTERY, POSTERIOR INFERIOR CEREBELLAR ARTERY, MIDDLE CEREBRAL ARTERY, landmarks located at the beginning of sphenoidal/horizontal segment, insular segment, opercular segment, cortial segment, POSTERIOR CEREBRAL ARTERY, landmarks located at the beginning of pre-communicating segment, post-communicating segment, quadrigeminal segment, cortical segment, POSTERIOR COMMUNICATING ARTERY, OPHTALMIC ARTERY, RIGHT AND LEFT CHOROIDAL ARTERY, BASILAR ARTERY, ANTERIOR SPINAL ARTERY, BRACHIOCEPHALIC ARTERY/TRUNK, RIGHT/LEFT SUBCLAVIAN ARTERY, RIGHT/LEFT COMMON CAROTID ARTERY, RIGHT/LEFT INTERNAL CAROTID ARTERY, RIGHT/LEFT EXTERNAL CAROTID ARTERY, RIGHT/LEFT VERTEBRAL ARTERY, RIGHT/LEFT THYROCERVICAL TRUNK, RIGHT/LEFT INTERNAL THORACIC ARTERY, RIGHT/LEFT COSTOCERVICAL TRUNK, RIGHT/LEFT SUPRASCAPULAR ARTERY, RIGHT/LEFT TRANSVERSE CERVICAL ARTERY, RIGHT/LEFT AXILLARY ARTERY, RIGHT/LEFT BRACHIUAL ARTERY, RIGHT/LEFT ULNAR ARTERY, RIGHT/LEFT RADIAL ARTERY, RIGHT/LEFT SUPERIOR THYROID ARTERY, RIGHT/LEFT LINGUAL ARTERY, RIGHT/LEFT FACIAL ARTERY, RIGHT/LEFT ASCENDING PHARYNGEAL ARTERY, RIGHT/LEFT OCCIPITAL ARTERY, RIGHT/LEFT POSTERIOR AURICULAR ARTERY, RIGHT/LEFT SUPERFICIAL TEMPORAL ARTERY, RIGHT/LEFT MAXILLARY ARTERY, POSTERIOR INTERCOSTAL ARTERIES, SUBCOSTAL ARTERIES, SUPERIOR PHRENIC ARTERIES, PERICARDIAL ARTERIES, OESOPHAGAL ARTERIES, ESOPHAGEAL BRANCHES OF INFERIOR THYROID ARTERY (TOP THIRD), ESOPHAGEAL BRANCHES OF THORACIC PART OF AORTA (MIDDLE THIRD), ESOPHAGEAL BRANCHES OF LEFT GASTRIC ARTERY (BOTTOM THIRD), LOWER DIAPHRAGMATIC ARTERIES, LUMBAR ARTERIES, CELIAC TRUNK, SUPERIOR MESENTRIC ARTERY, INFERIOR MESENTRIC ARTERY, MIDDLE SUPRARENAL ARTERY, RENAL ARTERIES, TESTICULAR ARTERY/INTERNAL SPERMATIC ARTERY/OVARIAN ARTERY, COMMON ILIAC ARTERIES, INTERNAL ILIAC ARTERIES, EXTERNAL ILIAC ARTERIES, FEMORAL ARTERIES, POPLITEAL ARTERIES, ANTERIOR TIBIAL ARTERIES, DORSAL ARTERIES OF FOOT, POSTERIOR TIBIAL ARTERIES, MEDIAL PLANTAR ARTERIES, LATERAL PLANTAR ARTERIES, V. CAVA SUPERIOR, VV. BRACHIOCEPHALICAE, V. SUBCLAVIA, VV. IUGULARES, V. CAVA INFERIOR, VV. ILIACAE COMMUNES, V. ILIACA EXTERNA, V. ILIACA INTERNA, VV. CORDIS, V. CARDIACA MAGNA, V. CARDIACA PARVA, V. CARDIACA MEDIA, V. POSTERIOR VENTRICULI SINISTRI, V. OBLIQUA ATRII SINISTRI, VV. CARDIACAE ANTERIORES, V. MARGINALIS DEXTRA, V. MARGINALIS SINISTRA, VV. CARDIACAE MINIMAE, VV. CEREBRI, V. CEREBRI INTERNA, V. SEPTI PELLUCIDI ANTERIOR, V. SEPTI PELLUCIDI POSTERIOR, V. THALAMOSTRIATA SUPERIOR, VV. THALAMOSTRIATAE INFERIORES, V. CHOROIDEA SUPERIOR, V. CHOROIDEA INFERIOR, V. CEREBRI MAGNA, VV. CEREBRI SUPERIORES, VV. CEREBRI INFERIORES, V. CEREBRI ANTERIOR, V. CEREBRI MEDIA PROFUNDA, V. CEREBRI MEDIA SUPERFICIALIS, VV. ANASTOMOTICAE, V. ANASTOMOTICA SUPERIOR, V. ANASTOMOTICA INFERIOR, V. BASALIS, V. COMMUNICANS ANTERIOR, V. COMMUNICANS POSTERIOR, CIRCULUS VENOSUS CEREBRI, V. COMMUNICANS POSTERIOR, V. SUPERIOR VERMIS, VV. HEMISPHAERII CEREBELLI SUPERIORES, V. VERMIS INFERIOR, VV. HEMISPHAERII CEREBELLI INFERIORES, VV. DIPLOICAE, V. DIPLOICA FRONTALIS, V. DIPLOICA TEMPORALIS ANTERIOR, V. DIPLOICA TEMPORALIS POSTERIOR, V. DIPLOICA OCCIPITALIS, VV. EMISSARIAE, V. EMISSARIA PARIETALIS, V. EMISSARIA MASTOIDEA, V. EMISSARIA CONDYLARIS, V. EMISSARIA OCCIPITALIS, PLEXUS VENOSUS FORAMINIS OVALIS, PLEXUS VENOSUS CAROTICUS INTERNUS, PLEXUS VENOSUS CANALIS HYPOGLOSSI, VV. MENINGEAE, VV. MENINGEAE MEDIAE, SINUS DURAE MATRIS, SINUS SAGITTALIS SUPERIOR, SINUS SAGITTALIS INFERIOR, SINUS S RECTUS, SINUS TRANSVERSUS, SINUS SIGMOIDEUS, SINUS OCCIPITALIS, CONFLUENS SINUUM, SINUS CAVERNOSUS, SINUS INTERCAVERNOSI, PLEXUS BASILARIS, V. OPHTHALMICA SUPERIOR, V. LACRIMALIS, VV. ETHMOIDALES, ANTERIOR ET POSTERIOR, V. NASOFRONTALIS, V. OPHTHALMICA INFERIOR, V. FACIALIS, V. ANGULARIS, V. SUPRATROCHLEARIS, V. SUPRAORBITALIS, VV. PALPEBRALES, VV. NASALES EXTERNAE, VV. LABIALES, V. PROFUNDA FACIEI, RAMI PAROTIDEI, V. SUBMENTALIS, V. PALATINA EXTERNA, V. RETROMANDIBULARIS, VV. TEMPORALES SUPERFICIALES, V. TEMPORALIS MEDIA, V. TRANSVERSA FACIEI, VV. ARTICULARES, V. STYLOMASTOIDEA, VV. AURICULARES ANTERIORES, VV. PAROTIDEAE, VV. MAXILLARES, V. IUGULARIS EXTERNA, V. AURICULARIS POSTERIOR, V. OCCIPITALIS, V. SUPRASCAPULARIS, VV. TRANSVERSAE COLLI, V. IUGULARIS ANTERIOR, PLEXUS PTERYGOIDEUS, V. SPHENOPALATINA, VV. MENINGEAE MEDIAE, VV. TEMPORALES PROFUNDAE, VV. ALVEOLARES SUP., VV. MASSETERICAE, V. ALVEOLARIS INFERIOR, V. VERTEBRALIS, V. VERTEBRALIS ANTERIOR, V. CERVICALIS PROFUNDA, V. IUGULARIS INTERNA, SINUS SIGMOIDEUS, SINUS OCCIPITALIS, PLEXUS VENOSUS CANALIS HYPOGLOSSI, V. CANALICULI COCHLEAE, SINUS PETROSUS INFERIOR, V. OCCIPITALIS, V. FACIALIS, VV. PHARYNGEALES, V. LINGUALIS, V. PROFUNDA LINGUAGE, VV. DORSALES LINGUAE, V. COMITANS N. HYPOGLOSSI, VV. THYROIDEAE SUPERIORES, VV. SUBFASCIALES, ARCUS VENOSUS PALMARIS PROFUNDUS, VV. RADIALES, VV. ULNARES, VV. BRACHIALES, V. BRACHIALIS COMMUNIS, V. BASILICA, VV. MUSCULUS, VV. COLATERALIS ULNAE, V PROFUNDA BRACHII, V. AXILLARIS, V. SUBCLAVIA, VV. CUTANEAE, VV. DIGITORUM, V. INTERCAPITALIS, ARCUS VENOSUS DIGITALIS PALMARIS, V. INTERDIGITALIS, ARCUS VENOSUS DIGITALIS DORSALIS, RETE VENOSUM DORSALE MANUS, VV. METACARPALES DORSALES, ARCUS VENOSUS METACARPALIS DORSALIS, VV. MARGINALES, V. SALVATELLA, V. CEPHALICA POLLICIS, V. CEPHALICA, V. CEPHALICA ANTEBRACHII, V. CEPHALICA ACCESSORIA, V. INTERMEDIA CUBITI, V. BASILICA, V. INTERMEDIA ANTEBRACHII, V. INTERMEDIA BASILICA, V. INTERMEDIA CEPHALICA, V. CAVA SUPERIOR, V. BRACHIOCEPHALICA, ANGULUS VENOSUS, V. THYROIDEA INFERIOR, VV. THYROIDEAE IMAE, V. VERTEBRALIS, V. CERVICALIS PROFUNDA, V. IUGULARIS EXT., VV. PERICARDIACOPHRENICAE, VV. THYMICAE, VV. PERICARDIALES, VV. MEDIASTINALES, VV. BRONCHIALES, VV. TRACHEALES, VV. ESOPHAGEALES, VV. THORACICAE INTERNAE, VV. MUSCULOPHRENICAE, VV. EPIGASTRICAE SUPERIORES, VV. INTERCOSTALES ANTERIORES, RAMI PERFORANTES, RAMI STERNALES, V. INTERCOSTALIS SUPERIOR, VV. CUTANEAE ABDOMINIS ET PECTORIS, PLEXUS VENOSUS AREOLARIS, VV. THORACOEPIGASTRICAE, VV. COSTOAXILLARES, V. AZYGOS, V. HEMIAZYGOS, PLEXUS VENOSI VERTEBRALES EXTERNI, PLEXUS VENOSI VERTEBRALES INTERNI, VV. BASIVERTEBRALES, VV. INTERVERTEBRALES, VV. SPINALES, VV. SPINALES INTERNAE, VV. SPINALES EXTERNAE, VV. RADICULARES, VV. DORSALES PEDIS, VV. PLANTARES LATERALES, ARCUS VENOSUS PLANTARIS, VV. PLANTARES MEDIALES, VV. METATARSALES PLANTARES, VV. PERFORANTES, VV. TIBIALES ANTERIORES, VV. TIBIALES POSTERIORES, VV. FIBULARES S. PERONEALES, V. POPLITEA, VV. GENICULARES, VV. SURALES, V. SAPHENA PARVA, V. FEMORALIS, V. EPIGASTRICA SUPERFICIALIS, V. CIRCUMFLEXA ILIACA SUPERFICIALIS, VV. THORACOEPIGASTRICAE, VV. PUDENDAE EXTERNAE: VV. SCROTALES ANTERIORES, VV. LABIALES ANTERIORES, VV. DORSALES SUPERFICIALES PENIS, VV. DORSALES SUPERFICIALES CLITORIDIS, V. SAPHENA MAGNA, V. PROFUNDA FEMORIS, VV. PERFORANTES, VV. CRICUMFLEXAE MEDIALES FEMORIS, VV. CRICUMFLEXAE LATERALES FEMORIS, VV. GLUTEAE SUPERIORES, VV. GLUTEAE INFERIORES, VV. DIGITALES DORSALES, VV. INTERCAPITALES, VV. METATARSALES DORSALES, ARCUS VENOSUS DORSALIS PEDIS, VV. DIGITALES PLANTARES, ARCUS VENOSUS PLANTARIS, RETE VENOSUM PLANTARE, RETE VENOSUM DORSALE, V. SAPHENA, V. SAPHENA PARVA, V. CAVA INFERIOR, VV. PHRENICAE INFERIORES, VV. LUMBALES, VV. HEPATICAE, VV. RENALES, V. SUPRARENALIS, V. TESTICULARIS, V. OVARICA, VV. ILIACAE COMMUNES, V. SACRALIS MEDIANA, V. ILIACA EXTERNA, V. CIRCUMFLEXA ILIACA PROFUNDA, V. EPIGASTRICA INFERIOR, V. ILIACA INTERNA, V. ILIOLUMBALIS, VV. SACRALES LATERALES, VV. GLUTEAE SUPERIORES, VV. GLUTEAE INFERIORES, VV. OBTURATORIAE, V. PUDENDA INTERNA, VV. PROFUNDAE PENIS RESP. CLITORIDIS, VV. BULBI PENIS RESP. VV. BULBI VESTIBULI VAGINAE, VV. SCROTALES POSTERIORES RESP. LABIALES POSTERIORES, VV. RECTALES INFERIORES, V. DORSALIS PENIS, VV. CRICUMFLEXAE PENIS, V. DORSALIS CLITORIDIS, VV. DORSALES PENIS SUPERFICIALES, VV. DORSALES CLITORIDIS SUPERFICIALES, PLEXUS VENOSUS RECTALIS, PLEXUS VENOSUS VESICALIS, PLEXUS VENOSUS PROSTATICUS, PLEXUS VENOSUS UTERINUS, PLEXUS VENOSUS VAGINALIS, V. PORTAE HEPATIS, V. MESENTERICA SUPERIOR, VV. IEIUNALES ET ILEALES, V. ILEOCOLICA, V. APPENDICULARIS, V. COLICA DEXTRA, VV. PANCREATICAE, V. GASTROOMENTALIS DEXTRA, V. PANCREATICODUODENALIS INF., V. SPLENICA S. LIENALIS, VV. PANCREATICAE, VV. GASTRICAE BREVES, V. GASTROOMENTALIS SINISTRA, V. MESENTERICA INFERIOR, VV. SIGMOIDEAE, V. COLICA SIN., V. RECTALIS SUP., V. GASTRICA SINISTRA, V. GASTRICA DEXTRA, V. PREPYROLICA, V. PANCREATICODUODENALIS SUPERIOR POSTERIOR, V. CYSTICA, V. UMBILICALIS, major duodenal papilla/papilla of Vater, inlet of cystic duct to common biliary duct, outlet of cystic duct from gallbladder, junction of right and left hepatic duct, junction of right anterior and right posterior hepatic duct, carina, subdivision to right superior lobar bronchus, subdivision to right middle lobar bronchus, subdivision to right inferior lobar bronchus, subdivision to left superior lobar bronchus, subdivision to left inferior lobar bronchus, subdivision to right first segmental bronchus, subdivision to right second segmental bronchus, subdivision to right third segmental bronchus, subdivision to right fourth segmental bronchus, subdivision to right fifth segmental bronchus, subdivision to right sixth segmental bronchus, subdivision to right seventh segmental bronchus, subdivision to right eight segmental bronchus, subdivision to right ninth segmental bronchus, subdivision to right tenth segmental bronchus, subdivision to right first segmental bronchus, subdivision to left first segmental bronchus, subdivision to left second segmental bronchus, subdivision to left third segmental bronchus, subdivision to left fourth segmental bronchus, subdivision to left fifth segmental bronchus, subdivision to left sixth segmental bronchus, subdivision to left seventh segmental bronchus, subdivision to left eighth segmental bronchus, anterior nares, outlet/drainage of right posterior ethmoidal cells to right sphenoethmoidal recess, outlet/drainage of left posterior ethmoidal cells to left sphenoethmoidal recess, outlet/drainage of right sphenoid sinus to right spheno-ethmoidal recess, outlet/drainage of right sphenoethmoidal recess to right superior nasal meatus, outlet/drainage of left sphenoethmoidal recess to left superior nasal meatus, outlet/drainage of right frontal sinus to right frontal recess, outlet/drainage of left frontal sinus to left frontal recess, outlet/drainage of right frontal recess to right middle nasal meatus, outlet/drainage of left frontal recess to left middle nasal meatus, outlet/drainage of right frontal ethmoidal cells to right ostiomeatal complex, outlet/drainage of right frontal ethmoidal cells to right ostiomeatal complex, outlet/drainage of right maxillary sinus to right ostiomeatal complex, outlet/drainage of left maxillary sinus to left ostiomeatal complex, outlet/drainage of right ostiomeatal complex to right middle nasal meatus, outlet/drainage of lewft ostiomeatal complex to left middle nasal meatus, outlet/drainage of right nasolacrimal duct to right inferior nasal meatus, outlet/drainage of left nasolacrimal duct to left inferior nasal meatus, postrior nares/posterior nasal aperture/chonoae, uvula, pharyngeal tonsil, opening of left and right auditory tube, tip of epiglottis, right and left piriform recess/fossa/sinus, postcricoid region, cricoid cartillage, interarytenoid fold, right and left aryepiglottic fold, right and left arytenoid cartillages, right and left vesibular fold, outlet of right and left laryngeal sacc, vocal chords, right and left vocal fold, first tracheal cartillage, Kidneys, Renal papilla, Minor calyxes, Renal pyramids, Renal pelvis, inlet ureter, Abdominal aortic plexus, Abducens nerves, Accessory nerve, Accessory obturator nerve, Alderman's nerve, Anococcygeal nerve, Ansa cervicalis, Anterior interosseous nerve, Anterior superior alveolar nerve, Auerbach's plexus, Auriculotemporal nerve, Axillary nerve, Brachial plexus, Buccal branch of the facial nerve, Buccal nerve, Cardiac plexus, Cavernous nerves, Cavernous plexus, Celiac ganglia, Cervical branch of the facial nerve, Cervical plexus, Chorda tympani, Ciliary ganglion, Coccygeal nerve, Cochlear nerve, Common fibular nerve, Common palmar digital nerves of median nerve, Deep branch of the radial nerve, Deep fibular nerve, Deep petrosal nerve, Deep temporal nerves, Diagonal band of Broca, Digastric branch of facial nerve, Dorsal branch of ulnar nerve, Dorsal nerve of clitoris, Dorsal nerve of the penis, Dorsal scapular nerve, Esophageal plexus, Ethmoidal nerves, External laryngeal nerve, External nasal nerve, Facial nerve, Femoral nerve, Frontal nerve, Gastric plexuses, Geniculate ganglion, Genital branch of genitofemoral nerve, Genitofemoral nerve, Glossopharyngeal nerve, Greater auricular nerve, Greater occipital nerve, Greater petrosal nerve, Hepatic plexus, Hypoglossal nerve, Iliohypogastric nerve, Ilioinguinal nerve, Inferior alveolar nerve, Inferior anal nerves, Inferior cardiac nerve, Inferior cervical ganglion, Inferior gluteal nerve, Inferior hypogastric plexus, Inferior mesenteric plexus, Inferior palpebral nerve, Infraorbital nerve, Infraorbital plexus, Infratrochlear nerve, Intercostal nerves, Intercostobrachial nerve, Intermediate cutaneous nerve, Internal carotid plexus, Internal laryngeal nerve, Interneuron, Jugular ganglion, Lacrimal nerve, Lateral cord, Lateral cutaneous nerve of forearm, Lateral cutaneous nerve of thigh, Lateral pectoral nerve, Lateral plantar nerve, Lateral pterygoid nerve, Lesser occipital nerve, Lingual nerve, Long ciliary nerves, Long root of the ciliary ganglion, Long thoracic nerve, Lower subscapular nerve, Lumbar nerves, Lumbar plexus, Lumbar splanchnic nerves, Lumboinguinal nerve, Lumbosacral plexus, Lumbosacral trunk, Mandibular nerve, Marginal mandibular branch of facial nerve, Masseteric nerve, Maxillary nerve, Medial cord, Medial cutaneous nerve of arm, Medial cutaneous nerve of forearm, Medial cutaneous nerve, Medial pectoral nerve, Medial plantar nerve, Medial pterygoid nerve, Median nerve, Meissner's plexus, Mental nerve, Middle cardiac nerve, Middle cervical ganglion, Middle meningeal nerve, Motor nerve, Muscular branches of the radial nerve, Musculocutaneous nerve, Mylohyoid nerve, Nasociliary nerve, Nasopalatine nerve, Nerve of pterygoid canal, Nerve to obturator internus, Nerve to quadratus femoris, Nerve to the Piriformis, Nerve to the stapedius, Nerve to the subclavius, Nervus intermedius, Nervus spinosus, Nodose ganglion, Obturator nerve, Oculomotor nerve, Olfactory nerve, Ophthalmic nerve, Optic nerve, Otic ganglion, Ovarian plexus, Palatine nerves, Palmar branch of the median nerve, Palmar branch of ulnar nerve, Pancreatic plexus, Patellar plexus, Pelvic splanchnic nerves, Perforating cutaneous nerve, Perineal branches of posterior femoral cutaneous nerve, Perineal nerve, Petrous ganglion, Pharyngeal branch of vagus nerve, Pharyngeal branches of glossopharyngeal nerve, Pharyngeal nerve, Pharyngeal plexus, Phrenic nerve, Phrenic plexus, Posterior auricular nerve, Posterior branch of spinal nerve, Posterior cord, Posterior cutaneous nerve of arm, Posterior cutaneous nerve of forearm, Posterior cutaneous nerve of thigh, Posterior scrotal nerves, Posterior superior alveolar nerve, Proper palmar digital nerves of median nerve, Prostatic plexus (nervous), Pterygopalatine ganglion, Pudendal nerve, Pudendal plexus, Pulmonary branches of vagus nerve, Radial nerve, Recurrent laryngeal nerve, Renal plexus, Sacral plexus, Sacral splanchnic nerves, Saphenous nerve, Sciatic nerve, Semilunar ganglion, Sensory nerve, Short ciliary nerves, Sphenopalatine nerves, Splenic plexus, Stylohyoid branch of facial nerve, Subcostal nerve, Submandibular ganglion, Suboccipital nerve, Superficial branch of the radial nerve, Superficial fibular nerve, Superior cardiac nerve, Superior cervical ganglion, Superior ganglion of glossopharyngeal nerve, Superior ganglion of vagus nerve, Superior gluteal nerve, Superior hypogastric plexus, Superior labial nerve, Superior laryngeal nerve, Superior lateral cutaneous nerve of arm, Superior mesenteric plexus, Superior rectal plexus, Supraclavicular nerves, Supraorbital nerve, Suprarenal plexus, Suprascapular nerve, Supratrochlear nerve, Sural nerve, Sympathetic trunk, Temporal branches of the facial nerve, Third occipital nerve, Thoracic aortic plexus, Thoracic splanchnic nerves, Thoraco-abdominal nerves, Thoracodorsal nerve, Tibial nerve, Transverse cervical nerve, Trigeminal nerve, Trochlear nerve, Tympanic nerve, Ulnar nerve, Upper subscapular nerve, Uterovaginal plexus, Vagus nerve, Ventral ramus, Vesical nervous plexus, Vestibular nerve, Vestibulocochlear nerve, Zygomatic branches of facial nerve, Zygomatic nerve, Zygomaticofacial nerve, Zygomaticotemporal nerve, Foramen caecum, Optic canal, Superior orbital fissure, Foramen rotundum, Foramen ovale, Foramen spinosum, Foramen lacerum, Carotid canal, Internal acoustic foramen, Jugular foramen, Hypoglossal canal, and Foramen magnum.

Another aspect of the invention pertains to a computer-readable [storage] medium comprising instructions which, when executed by a computer, cause the computer to carry the steps according to any embodiment of the invention.

Another aspect of the invention involves a system for defining of coordinates of landmarks in a volume of medical images, wherein the system comprises a measuring means for collection a computational tomography volume or a magnetic resonance volume, for a human patient, and a computer system adapted to perform the steps of any embodiment of the method of the invention.

In one embodiment, the system according to the invention comprises a computer system that is adapted to perform the steps of a method that includes embodiments with training. This embodiment allows for even faster obtaining of coordinates. In particular, for this embodiment an operator gathering CT or MR images can prepare annotations indicating landmarks at least for a part of said images thereby allowing the method of the invention to learn using said part of images and define coordinates for the rest of images. This also allows the method to be tuned towards particular landmarks since annotations comprise particular landmarks.

Further characteristics and advantages of the invention will be more apparent from the detailed description of non-limiting embodiments and from the appended figures. It should be understood that embodiments presented in the description and in the claims, unless stated otherwise, can be combined together in any order and number to produce new embodiments that form part of the disclosure. The description comprises a great number of references to prior art documents, in particular to scientific journals. The full disclosure of said references is part of this disclosure.

### BRIEF DESCRIPTION OF FIGURES

The invention will now be described in more detail with reference to the appended figures.

FIG. 1 depicts application of an embodiment of method of the invention including trained residual U-Net.

FIG. 2 shows a detailed diagram of an embodiment of method of the invention including training steps.

FIG. 3 presents an architecture of a residual U-Net according to an embodiment of a method of the invention.

FIG. 4 presents an architecture of an encoding block according to an embodiment of the invention.

FIG. 5 presents an architecture of an decoding block according to an embodiment of the invention.

FIG. 6 shows a more detailed steps of training of a residual U-Net according to an embodiment of a method of the invention.

FIG. 7 presents exemplary slices from two datasets with coronary ostium annotations. The first row shows examples from the CCTA dataset and the second from the ImageTBAD CTA dataset.

FIG. 8 presents a 3D rendered example from the CCTA dataset showing localization of the left coronary ostium and the right coronary ostium.

FIG. 9 presents a success detection rate (SDR) for landmark localization in the experiments on the CCTA dataset and the ImageTBAD CTA dataset.

### DETAILED DESCRIPTION

The forgoing description is focused on embodiments including computational tomography volumes. Magnetic resonance (MR) image volumes can also be used in said embodiments following adaptation of said embodiments.

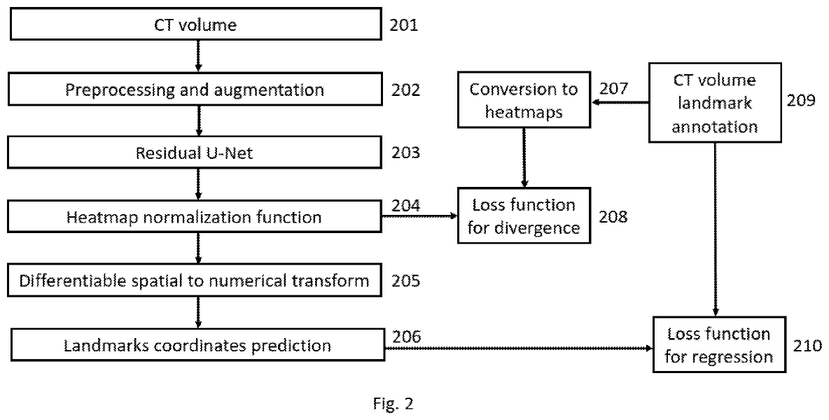

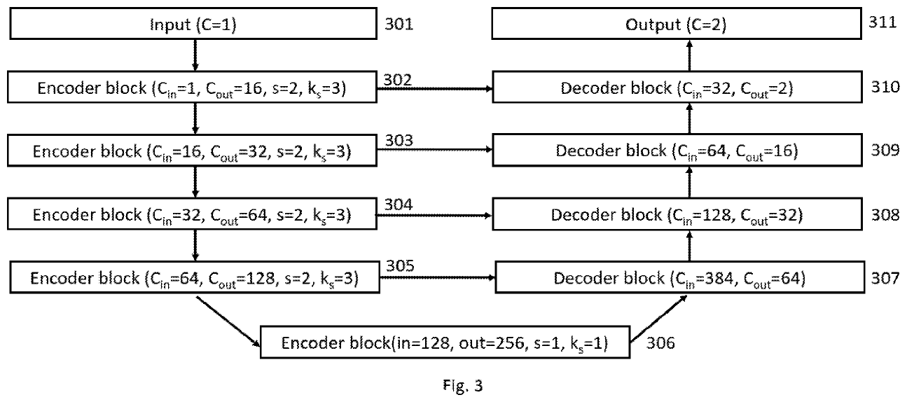

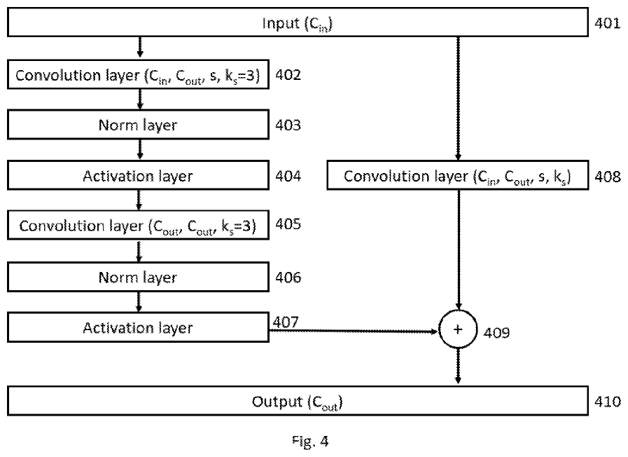

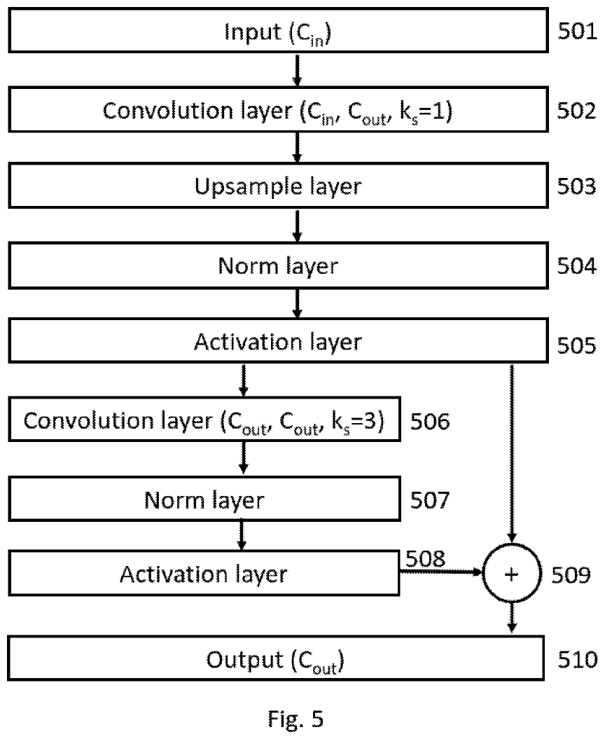

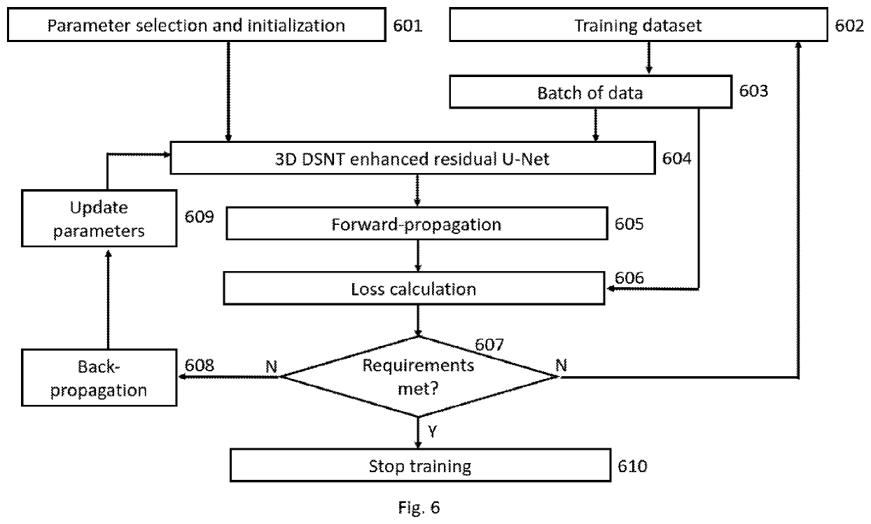

The core of one of embodiment of the invention is deep learning model with 3D Differentiable spatial to numerical transform (DSNT) enhanced with a residual U-Net architecture 103. In other embodiments, residual U-Net architecture can be used without DSNT. To use the model, it first must be trained. Various embodiments of the method including training and details of the architecture are illustrated in FIG. 2, FIG. 3, FIG. 4, FIG. 5 and FIG. 6 and described herein. In one embodiment, output are coronary ostium landmark coordinates 104. Once the model 103 is trained, in one embodiment, it infers two predictions of coordinates with a sub-voxel precision for a given preprocessed input CT volume. One coordinate prediction for the left coronary ostium and one coordinate prediction for the right coronary ostium. Each coordinate includes three numbers for the sagittal, coronal and axial position, respectively. The use of the invention including a trained model is referred to as the inference phase. Training of the model is referred to as the training phase.

The invention will be presented in detail for coronary ostia landmarks. However, the invention is applicable to other modalities and other landmarks. This requires different datasets to be used and, if needed, preprocessing step or steps. A skilled person will understand that different data preprocessing may be needed for different datasets. The principle of preprocessing, which can be defined as obtaining a dataset easier to use in a particular detection, remains the same. In order to perform localization of a different number of points, Cₒᵤₜ in a decoding block (310) has to be set to a different number. Thereby, an output (311) will include said different number of landmark predictions. List of landmarks for which detection of coordinates can be made is included in the description and in the appended claims.

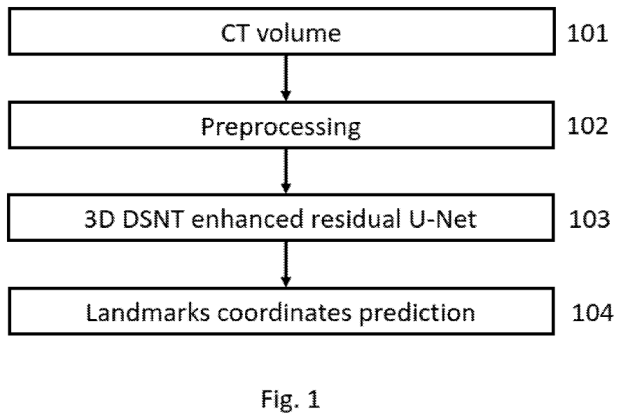

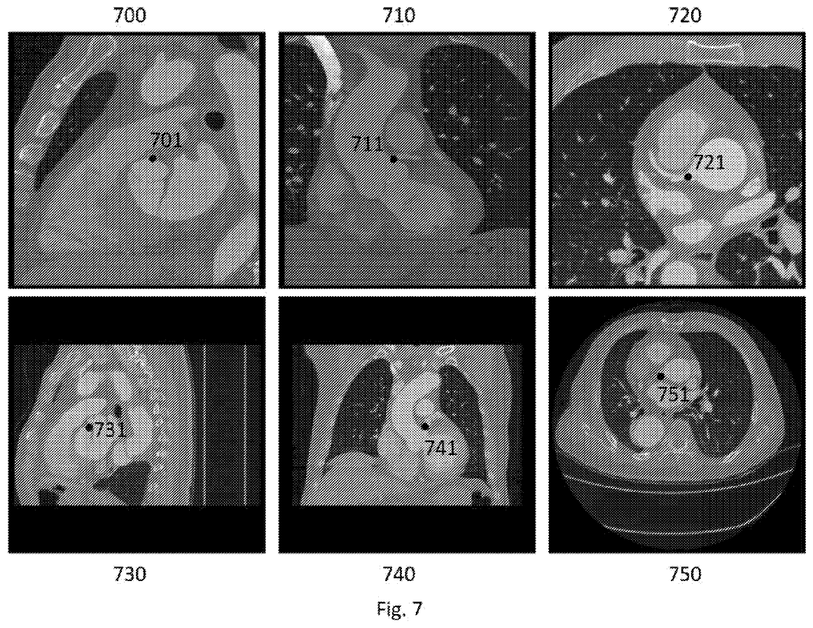

FIG. 1 illustrates application of a method adapted to coronary ostia detection in a CT volume 101 according to the invention comprising a trained residual U-Net. A CT volume is a 3-dimensional gird composed of 3-dimensional pixels named voxels. Each voxel contains the information of relative radiodensity. Voxels are usually displayed according to the mean attenuation of the tissue that it corresponds to in the Hounsfield units (HU). Values range from +3 071 HU to −1 024 HU in the Hounsfield scale. Volumes are expected to be calibrated to water with an attenuation of 0 HU. Typical volumes have 512 voxels in width, 512 voxels in height and z number of voxels in length. The z number of voxels in length depends on the number of slices. For example, the CTA volume in FIG. 7 shown in 730, 740 and 750 images, has 330 slices, and therefore contain 512×512×330 voxels in total having 330 voxels in length. For example, the CCTA volume in FIG. 7 shown in 700, 710 and 720 slices has a voxel size of 0.3281×0.3281×0.4 mm³.

The input CT volume is preprocessed 102 to remove unnecessary information and to normalize it to make the method less computationally demanding. In the preprocessing step, voxels in the volume are clipped to the range from −300 HU to 1100 HU. That is, every value smaller than −300 HU is set to −300 HU and each value higher than 1100 HU is set to 1100 HU. Next, voxel values are normalized by linearly scaling them to values from 0 to 1. That is, each voxel of −300 HU is set to 0, each voxel of 1100 HU is set to 1, and voxels with values between −300 HU and 1100 HU are set to corresponding values in the scale from 0 to 1. Other normalization techniques can be used. To keep the most information and to resolve memory issues, volumes are downsized in the preprocessing step. In one embodiment, the volume is downsized to a spatial size of 144×144×144 voxel using trilinear interpolation. Other interpolation techniques can be used. In other embodiments, the input CT volume is downsized by 3-4 times, in particular 3.1, 3.2, 3.3, 3.4, 3.5, 3.6, 3.7, 3.8 or 3.9 times. Even though downsizing makes data less detailed and spatially accurate, it was shown that accuracy of results obtained using the method according to the invention did not suffer and even surpassed known methods using local refinement.

FIG. 2 illustrates details of the training phase of the model on a single input volume. A trained model used in the invention does not require 207, 208, 209 and 210 from FIG. 2 and augmentation of a CT volume.

The training phase comprises an input volume x 201. Same input can be used in the inference phase. The training phase, in one embodiment, also comprises inputting coordinates of two coronary ostia y, wherein the coordinates are provided by trained radiologists (CT landmark annotation 209). In the same embodiment, the training phase comprises providing two coronary ostia localizations ŷ (landmarks coordinates prediction 206).

In general, the method combines a heatmap matching regression with extraction of heatmap center coordinates (shown in step 210) by a Differentiable Spatial to Numerical Transform (DSNT) layer shown in step 205.

### Preprocessing and Augmentation for Training

Volumes can be preprocessed in the same manner in the training phase and in the inference phase. In one embodiment, preprocessing in the training phase additionally includes augmenting volumes as disclosed in this application. The input volume can be preprocessed and subsequently augmented 202. Voxels can be clipped to the range from −300 HU to 1100 HU. In that embodiment, every value smaller than −300 HU is set to −300 HU and each value higher than 1100 HU is set to 1100 HU. Next, voxel values are normalized by linearly scaling them to values from 0 to 1. That is, each voxel of −300 HU is set to 0, each voxel of 1100 HU is set to 1, and HU values between −300 HU and 1100 HU are set to a corresponding value, for example, in the scale from 0 to 1. Finally, the volume can be resized to a spatial size of 144×144×144 voxels using trilinear interpolation. Other spatial size and other interpolation techniques can be used. In addition to that, the input volume can be augmented with rotations up to π/6 radians and translations up to 10 voxels in each dimension.

An additional preprocessing step in the form of central cropping can be applied to each volume during training and inference phases for the ImageTBAD CTA dataset. The central cropping may include, in one example, a 112 voxel cut from a volume of size of 512×512×Z voxel on slices along Z-axis to arrive at a volume of 288×288×Z. The central cropping removes unnecessary regions from the volume and keeps the hearth area only.

### Heatmap Generation

In general, the unnormalized heatmap H=f_{Θ}(x) is an output from a model f_{Θ} which is parameterized by learnable parameters (also called weights) Θ with an input volume x. At step 203, the f_{Θ} model that acts as a backbone feature extracting network in this invention is the residual U-Net [10, 30] that adopts a classic U-Net architecture [21] and combines it with a residual neural network. A residual U-Net of the invention finds heatmaps which can be called features found by said residual U-Net. For avoidance of doubts, f_{Θ} represents residual U-Net. Θ are found during training and remain unchanged in application (the inference phase). A skilled person knows that there are many residual U-Net architectures and the difference between them is structure of encoding residual and decoding residual blocks included in said architectures. The structure of said residual blocks influences application of a particular residual U-Net architecture. As the result, a particular structure of residual U-Net architecture can be defined by its purpose. Despite this and in order to provide a full disclosure of the invention, details of embodiments of residual U-Net architecture of the invention are provided in the description and in the claims.

FIG. 3 illustrates the residual U-Net architecture according to an embodiment of the invention. It receives an input volume 301. The input 301 is passed to a series of encoding residual blocks (302, 303, 304, 305) which sequentially decrease the dimensionality and resolution size of the volume until achieving the last encoding residual block 306. In FIG. 3 encoder block and decoder block are used instead of encoding residual block and decoding residual block, respectively, for brevity.

In embodiments, an encoding residual block receives an input volume with a certain input (Cᵢₙ) number of channels and outputs a volume with an output (Cₒᵤₜ) number of channels. It also decreases the size of a volume depending on the value of stride (s). When stride equals, for example, two, the output volume decreases its size by two. When stride equals one, the volume does not decrease its size. Usually, all convolution kernels in the encoding convolution layers of the encoding residual block have dimension of 3×3×3, and it is denoted as kₛ=3. kₛ=1, as in the encoding residual block 306, means that the kernels dimension of the encoding convolution layer in the mapping function in the encoding residual block is of size 1×1×1. Encoding residual blocks are also connected to corresponding decoding residual blocks (307, 308, 309, 310) to share information which would be otherwise be lost during the decrease of spatial size. Sharing should be understood as making a copy of the information. In other words, each encoding residual block that is connected to another encoding residual block outputs the same information twice and one copy is transferred to another encoding residual block and one copy is transferred to a corresponding decoding residual block.

Each volume contains X, Y, Z and C dimensions. X, Y, Z are called spatial or shape dimensions. C is the number of channels. A volume in the architecture of the residual U-Net, according to an embodiment, is transferred as described below: Input volume 301 with 1 channel (grayscale Hounsfield scale) goes to the encoding block 302 and produces volume with 16 channels and half the size in shape (stride=2). Copies of the signal follow to encoding block 303 and decoding block 310. Encoding block 303 produces volume with 32 channels downsampled by a factor of two (stride=2). Copies of the signal follow to encoding block 304 and decoding block 309. Encoding block 304 produces volume with 64 channels downsampled by a factor of two (stride=2). Copies of the signal follow to encoding block 305 and decoding block 306. Encoding block 305 produces volume with 128 channels downsampled by a factor of two (stride=2). Copies of the signal follow to encoding block 306 and decoding block 307. Encoding block 305 produces volume with 128 channels and does not change the volume size as opposed to other encoding blocks (stride=1). The output from 306 goes to the decoding block 307. The decoding block 307 concatenates signal from encoding blocks 305 and 306 resulting in a volume with 384 channels on its input. The decoding block 307 produces volume with 64 channels upsampled by a factor of two. The output from 307 goes to the decoding block 308. The decoding block 308 concatenates signal from encoding blocks 304 and 307 resulting in a volume with 128 channels on its input. The decoding block 308 produces volume with 32 channels upsampled by a factor of two. The output from the decoding block 306 goes to the decoding block 309. The decoding block 309 concatenates signal from encoding block 303 and 308 resulting in a volume with 64 channels on its input. The decoding block 309 produces volume with 16 channels upsampled by a factor of two. The output from the decoding block 309 goes to the decoding block 310. The decoding block 310 concatenates signal from the encoding block 302 and 309 resulting in a volume with 32 channels on its input. The decoding block 310 produces volume with 2 channels upsampled by a factor of two. The last step in architecture is the output volume 311 of the same spatial size as the input volume 301 but with two channels. In embodiments, each channel corresponds to the estimated probability of a landmark localization. One for the probability of the left coronary ostium localization, one for the probability of the right coronary ostium localization. In other embodiments, number of channels, downsampling factor, upsampling factor and/or stride values can be different.

Each residual block, both encoding and decoding, can be defined as follows:

$${y}_{l} = h ( {x}_{l} ) + F ( {x}_{l} , {W}_{l} ) , \qquad ( 1 )$$

$${x}_{l + 1} = f ( {y}_{l} ) ,$$

where xₗ and xₗ₊₁ are the input and output of the l-th residual unit, [symbol] (·) is a residual function, f(y₁) is an activation function and h(xₗ) is usually an identity mapping function. The residual function [symbol] (·) depends on the residual block structure. For each encoding block it is defined as a product of: 402, 403, 404, 405, 406, 407. For each decoding block it is defined as a product of: 506, 507, 508.

FIG. 4 illustrates architecture of an encoding residual block according to an embodiment of the invention. Each encoding residual block comprises encoding layers. For brevity, the word “encoding” is omitted on the figure. A volume which enters an encoding residual block can be called an encoding residual block input. An encoding residual block receives an input volume 401 with a certain input (Cᵢₙ) number of channels and outputs a volume with an output (Cₒᵤₜ) number of channels 410. 402 is the first encoding convolution layer and 405 is the second encoding convolution layer in the residual function [symbol] (·) of an encoding residual block. At 408 a mapping function h(xₗ)=conv(xₗ, K, Cᵢₙ, Cₒᵤₜ, s) which consists of a single encoding convolution layer is applied.

For an encoding residual block according to an embodiment of the invention, h(xₗ)=conv(xₗ, K, Cᵢₙ, Cₒᵤₜ, s) and it is defined as follows:

$$conv ( {x}_{l} , K , {C}_{in} , {C}_{out} , s ) = {\sum }_{c = 0}^{{C}_{in} - 1} ( {K}_{{C}_{out} , c} ★ {x}_{{l}_{c}} ) ,$$

where * is either the 3D cross-correlation operator or a strided version of it. Cᵢₙ is the number of input channels, Cₒᵤₜ is the number of output channels. K is a set of learnable weights in the form of convolution kernels and s is the stride value. The 3D cross-correlation is defined as follows:

$$K ★ I ( x , y , z ) = {\sum }_{i = - N}^{N} {\sum }_{j = - N}^{N} {\sum }_{l = - N}^{N} K ( i , j , l ) \times I ( x + i , y + j , z + l ) ,$$

Where K is a kernel, defined as a 3D matrix of size N×N×N, and I(x,y,z) is a voxel of an example input volume I of coordinates x,y,z. The strided version of the 3D cross-correlation is defines as:

$$K {★}_{s} I = {\sum }_{p = 1}^{s} {\sum }_{q = 1}^{s} {\sum }_{r = 1}^{s} {K}_{p , q , r} ★ {I}_{p , q , r} ,$$

where K is a kernel, defined as a 3D matrix, I is an example input volume, and s is the stride.

A first encoding convolution layer 402 and a subsequent encoding convolution layer 408 increase the number of channels from Cᵢₙ to Cₒᵤₜ, while a second encoding convolution layer 405 does not change the number of channels and for it Cᵢₙ=Cₒᵤₜ. The first encoding convolution layer 402 as well as the subsequent encoding convolution layer 408 use the strided 3D cross-correlation operator, while the second encoding convolution layer 405 does not use stride (i.e., stride is equal one). The first encoding convolution layer 402 and the second encoding convolution layer 405 have kernel size kₛ=3 which means that the kernel size is of dimension 3×3×3. The subsequent encoding convolution layer 408 has a kernel size kₛ which equals three for encoding residual blocks 302, 303, 304, 305 and equals one for the encoding residual block 306.

Encoding convolution layers 402 and 405 are followed by encoding norm layers 403 and 406, respectively. Examples of encoding norm layers include batch normalization [33], instance normalization [36], layer normalization [37], group normalization [35] etc. In one embodiment a 3D Batch Normalization is used. It is defined as follows:

$$y = \frac{x - E [ x ]}{\sqrt{Var [ x ] + ϵ}} \cdot γ + β ,$$

where x is the input, and y output of the encoding norm layer. γ and β are learnable parameters and ϵ is a small constant value added to the denominator for numerical stability.

Encoding norm layers 403 and 406 are followed by encoding activation layers including activation functions 404 and 407, respectively. Examples of activation functions include tanh, Rectified Linear Unit (ReLU), Parametric Rectified Linear Unit (PReLU) etc. In one embodiment, a PReLU is used. It is defined as follows:

$$f ( {y}_{i} ) = {y}_{i} if {y}_{i} \geq 0 ,$$

$$f ( {y}_{i} ) = {α}_{i} {y}_{i} if {y}_{i} < 0$$

where yᵢ is the i-th element of the input volume y, and a is a learnable parameter.

The output from 407 and 406 are merged with an element-wise addition function, which is defined as a regular matrix addition 409 and result in the output volume 410 of a shape Cₒᵤₜ.

FIG. 5 illustrates architecture of a decoding residual block of an embodiment of the invention. Each decoding residual block comprises decoding layers. For brevity, the word “decoding” is omitted on the figure. A volume which enters a decoding residual block can be called a decoding residual block input. A decoding residual block receives an input volume 501 with a certain input (Cᵢₙ) number of channels and outputs a volume with an output (Cₒᵤₜ) number of channels 510. First, the input volume goes to 502, which is a first decoding convolution layer as defined for 402, 405, or 408. It decreases the number of channels from Cᵢₙ to Cₒᵤₜ. It uses unstrided 3D cross-correlation operator. The decoding convolution layer 502 uses a constant kernel size kₛ=1 of size 1×1×1. 503 upsamples the volume spatially by the factor of two using nearest neighbor interpolation. 504 applies a decoding norm layer, here a 3D Batch Normalization as defined for 403 or 406. 505 is a first decoding activation layer, here a PReLU as defined for 404 or 407. 506 is a second decoding convolution layer in the residual function of the residual decoding block. It is defined as in 402, 405 and 408. It keeps the same number of channels Cₒᵤₜ. The second decoding convolution layer 506 uses a constant kernel size kₛ=3 of size 3×3×3. It is followed by a second decoding norm layer 507, here a 3D Batch Normalization as defined for 403 or 406. The second decoding norm layer 507 is followed by a second decoding activation layer 508, here a PReLU as defined for 404 or 407. The output from 505 and 508 are merged with an element-wise addition function, which is defined as a regular matrix addition 509 and result in the output volume 510 of a shape Cₒᵤₜ. For a decoding residual block, the mapping function has the form of h(xᵢ)=xᵢ and is a connection between 505 and 509 of FIG. 5.

The learnable parameters, which are parameters changed during the training phase, are: kernel weights K for the convolutional layers, parameters γ and β in the Batch normalization layers and parameter a in the activation layers.

### Heatmap Normalization Function

FIG. 2. 204. A normalization function φ(·) is a rectification operation followed by the L¹ normalization. A one-channel heatmap H output from the residual U-Net is normalized by the normalization function to produced normalized one-channel heatmap Ĥ. Ĥ is outputted to 208 and to 205.

### 3D DSNT

FIG. 2. The 3D Differentiable Spatial to Numerical Transform (3D DSNT) [16] 205 is a fully differentiable and a non-trainable layer. Due to this fact, numerical coordinates can be obtained during training and can be used as a learning criterion since back-propagation does pass via the 3D DSNT.

We define the 3D extension of the DSNT as follows:

$$D S N T ( \hat{H} ) = [ {〈 \hat{H} , X 〉}_{F} , {〈 \hat{H} , Y 〉}_{F} , {〈 \hat{H} , Z 〉}_{F} ] , \qquad ( 2 )$$

where Ĥ=φ(H), and Ĥ is a one-channel heatmap H output from the residual U-Net normalized by a normalization function (step 204). <·, ·>_{F} represents a Frobenius inner product of two matrices. The two matrices are selected from A, X, Y and Z.
X, Y and Z are grids in the form of m×n×l matrices used to calculate expected values of a landmark's coordinate and are defined as:

$${X}_{i , j , k} = \frac{2 j - ( n + 1 )}{n} , {Y}_{i , j , k} = \frac{2 i - ( m + 1 )}{m} , {Z}_{i , j , k} = \frac{2 k - ( l + 1 )}{l} , \qquad ( 3 )$$

Each entry of X, Y and Z contains its own coordinates, scaled such that the top-left-upper corner of the volume is at (−1,−1,−1) and bottom-right-down is at (1,1,1).

### Loss Functions

Coronary ostia localization manually annotated by trained radiologists are provided in step 209. The conversion from coronary ostia localizations manually annotated to annotated heatmaps is done in step 207. This can be done assuming a normal distribution of coronary ostia localizations on heatmaps.

In 208, minimalization of the divergence between Ĥ and an annotated heatmap is done. This can be done using a Jensen-Shannon divergence regularization [symbol] _{D} as a term to calculate and by performing minimization of the divergence between A and an appropriate target normal distribution [symbol] (y,σ²) with a being a hyper-parameter that controls the spread of the desired distribution.

In 210, minimalization of the Euclidean distance between coronary ostia localizations manually annotated and coronary ostia localizations provided by 3D DSNT is done. We can utilize the popular Euclidean metric [symbol] _{E} between the network output ŷ=DSNT(Ĥ) and the ground-truth y. It has been shown [16] that forcing the network to produce heatmaps with normal distribution of probability (e.g., gaussian-like) improves the quality of the overall prediction.

The complete loss is defined as a linear combination of loss function for divergence (208) and loss function for regression (210) can be defined as:

$$ℒ ( \hat{H} , y ) = {ℒ}_{E} ( D S N T ( \hat{H} ) , y ) + {λℒ}_{D} ( \hat{H} , y ) = {ℒ}_{E} ( \hat{y} , y ) + {λℒ}_{D} ( \hat{H} , y ) , \qquad ( 4 )$$

where λ is a regularization coefficient hyperparameter controlling the strength of the regularization.

The Euclidean loss LE (can be used in 210) can be defined as:

$${ℒ}_{E} ( \hat{y} , y ) = {‖ \hat{y} - y ‖}_{2} , \qquad ( 5 )$$

and the Jensen-Shannon divergence regularization LD (can be used in 208) can be defined as:

$${ℒ}_{D} ( \hat{H} , y ) = {D}_{JS} ( \hat{H} ‖ 𝒩 ( y , {σ}^{2} ) ) , \qquad ( 6 )$$

where D_{JS}(·∥·) is the Jensen-Shannon divergence [11].

### Training Procedure

FIG. 6 illustrates an exemplary training procedure of the method with more details. Step 602 requires a training dataset, which can be a dataset requiring landmark prediction. The training dataset can be the same dataset which requires landmark detection. In embodiments, CCTA or CTA datasets are used. The training dataset is split into training and validation data splits. The training dataset split is used to train the model weights, while the validation data split is used to validate the model performance after each epoch of training. An epoch includes one iteration over all volumes in the training data split.

For the CCTA dataset a cross-validation with 3-folds can be used. This gives 104 volumes in the train data split and 53 in the validation data split per fold. For the Image TBAD dataset, a cross-validation with 4-folds can be used to produce 58 volumes in the train data split and 19 in the validation data split per fold. Each volume x in the dataset has a corresponding landmark annotation y.

At step 601 a set of training parameters (weights) is initialized, and training parameters are selected. There are two sets of parameters: trainable parameters and parameters of training (hyperparameters). The deep learning model weights W comprises all trainable parameters. That is W comprises of kernel weights K in convolutional layers, parameters γ and β in batch normalization layers, and parameter a in PReLU activation layers. In one embodiment, model weights are initialized as follows: kernel weights K for the convolutional layers are initialized by sampling from the Kaiming Uniform Distribution as described in [32]. Parameters γ and β in the Batch normalization layers are set to ones and zeros, respectively. Parameter a in the PReLU activation layers is initialized to 0.25. These weights are used as initialization weights in step 601 and are updated after each iteration during the training phase.

We can use the following training parameters: 1) The number of epochs, which is the maximum number of epochs used in the training phase. For example, it can be set to 1 000 epochs. 2) A training batch size value, which is the number of training volumes in one iteration of training, is usually limited be the GPU memory on which the training takes place. It can be set to four. That is four volumes are concatenated and passed through the network in a single iteration of training. Other values can be used. 3) A learning rate, which controls the strength of the weights update, is a scalar which is multiplied by the weight's derivative during training. It can be set to 0.00025. 4) A hyperparameter of choice can be an optimization algorithm. The Adam optimization algorithm as defined in [34] can be used as a hyperparameter. 5) Next, a hyperparameter is used as the evaluation metric. This hyperparameter is defined to monitor the model quality and is used for evaluation after each epoch. In one embodiment, we define said hyperparameter as the localization accuracy on the validation data split. 6) Stopping criterion is a hyperparameter used for early stopping of the training phase. In one embodiment, it is defined as reaching the max number of epochs, which can be 1 000. Other number can be used. 7) Finally, a hyperparameter specific to the invention's architecture is parameter σ which controls the spread of distribution of localization annotation in the divergence loss and a regularization rate parameter λ which controls the strength of the divergence loss effect. In one embodiment, parameters are set to σ=3 and λ=1.

A 3D DSNT enhanced with a residual U-Net of 604 (deep learning model) and 103 includes the residual U-Net 203, Heatmap normalization function 204, and the 3D DSNT 205. In each iteration it receives a batch of data 603 from the training data split 602 which comprises training CT input volumes 201 and corresponding CT landmark annotations 209. The deep learning model 604 infers predictions from the batch of data 603 using the current values of weights in the Forward-propagation step 605. These predictions are then used in the loss calculation step 606 together with corresponding data annotations of the batch of data 603. The loss calculation step 606 comprises the loss function for divergence from step 208 and the loss function for regression from step 210. As shown in step 207, a CT landmark annotation 209 has to be converted into a heatmap in order to calculate the divergence loss 208.

Once the loss is calculated, after each epoch, the model of the invention infers a prediction for the entire data validation split. The decision to continue training is made in step 607 after each epoch. If the requirements are not met, a back-propagation step 608 is performed to calculate weights gradient with respect to the calculated loss 606 using, for example, the chain rule. Specifically, given the complete loss function L= [symbol] (Ĥ,y) 606 or the current training iteration, a gradient is calculated for each deep learning trainable parameter weight Wᵢ, where Wᵢ is the i-th trainable parameter. If the model has m trainable parameters, the gradient of the loss function is defined as follows:

$$\frac{\partial L}{\partial W} = [ \frac{\partial L}{\partial {W}_{1}} , \frac{\partial L}{\partial {W}_{2}} , … , \frac{\partial L}{\partial {W}_{m}} ] .$$

In one embodiment, a stochastic gradient-descent version of the back-propagation is used over the training batch. The gradients show how much the parameter Wᵢ needs to be changed in a positive or a negative direction to minimize the loss L 606.

Weights are updated according to the loss gradient from 608 according to the optimizer and its learning rate in 609. An optimizer is an algorithm that modifies the attributes of the neural network, such as weights and learning rate. Thus, it helps in reducing the overall loss and improve the accuracy. In one embodiment the Adam optimization algorithm is used as defined in [34].

The batch of data 603 for the next iteration is updated with new volumes and annotations from the training data 603 in each iteration.

The training continues, batch after batch in each iteration over all epochs, until the requirements 607 are met.

If the requirements in step 607 are met, the training procedure stops in step 610 and the model weights are trained and ready to be used in the 3D DSNT enhanced residual U-Net in the inference phase as illustrated in FIG. 1.

### Datasets

### CCTA Dataset

The CCTA dataset comprises of 157 CCTA volumes gathered from eight different medical centers. It comprises of 67 volumes of female and 90 volumes of male patients who are in average 69.7±11.1 years old. Images were acquired from six kinds of scanners: Siemens SOMATOM Force, Siemens SOMATOM Definition Flash, Siemens Sensation Cardiac 64, Canon Medical Systems Aquilion ONE, GE Medical Systems Discovery CT750 HD, and GE Medical Systems Optima CT660. Volumes have a size of 512×512×(130-420), with spacing 0.4-0.6 mm and a typical voxel size of 0.25 mm. Landmarks include the position of the left and the right coronary ostium and are manually annotated by trained radiologists.

### ImageTBAD CTA Dataset

The ImageTBAD CTA dataset [29] is a computed tomography angiography (CTA) image dataset of Type-B Aortic Dissection. The dataset comprises of 100 CTA images gathered from Guangdong Provincial Peoples' Hospital, China. It comprises of 31 volumes of female and 69 volumes of male patients who were in average 52.5±11.3 years old. Images were acquired from two kinds of scanners: Siemens SOMATOM Force, and Philips 256-slice Brilliance iCT system. Volumes have a size of 512×512×(135-416), with spacing of 0.75 mm and a typical voxel size of 0.25 mm. The dataset comprises of Type-B aortic dissection segmentation annotations and was extended for the purpose of this invention by trained radiologists. Identically to the CCTA dataset, landmarks include the position of the left and the right coronary ostium and were manually annotated by trained radiologists. During the annotation 23 volumes were discarded due to the insufficient data quality and reconstruction artefacts in the ostium neighborhood resulting in 77 volumes with coronary ostia annotations. The inventors shared these annotations with the public for further use.

Comparison with Known Methods

The method according to the invention was compared with three popular regression methods using the two datasets described above. For a reliable comparison of all methods, the popular regression methods used in comparison comprised the same residual U-Net backbone as is used in the invention. The three popular regression methods were CNN (which consist of U-Net encoding part)+FC for coordinates regression, Residual U-Net+FC for coordinates regression, and Residual U-Net Heatmap regression with argmax. We used standard evaluation criteria [as disclosed in 17] to compare the methods on the task of landmark detection. The standard evaluation criteria comprised the Euclidean distance (EUC) with its median, mean, standard deviation (STD), interquartile range (IQR) and Success Detection Rate (SDR). SDR is defined as the percentage of predicted landmarks which have the Euclidean distance to the reference landmark below the given threshold.

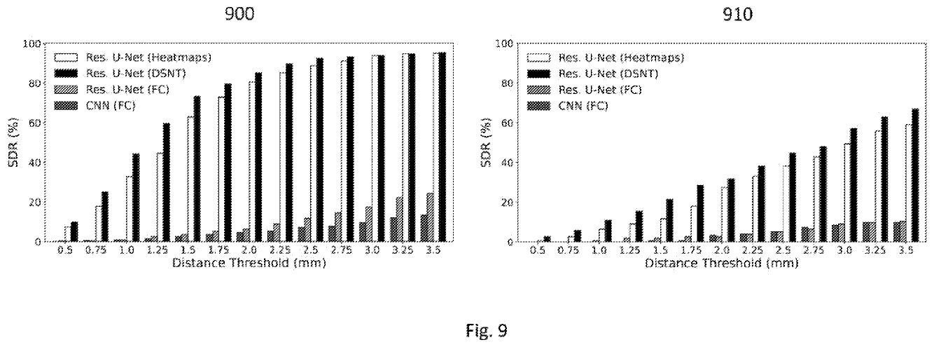

Table 1 shows a comparison between the method according to the invention and the three popular methods. The SDR histogram plots are shown in FIG. 9. The trend is similar for both datasets. Architectures, which use fully connected (FC) layer at the end of a backbone performed poorly in comparison. This proves that for the task of ostia regression, or landmark regression in particular, utilizing heatmap generation is beneficial over exact coordinate regression. In general, the use of argmax over heatmaps and the use of DSNT according to the invention performed much better. The method with DSNT achieved a median Euclidean distance error of 1.11 mm and 1.05 mm and a mean Euclidean distance error of 1.32±0.94 mm and 1.48±1.66 mm and IQR of 0.76 mm and 0.79 mm on the left and right ostium, respectively, on all 157 scans by applying a 3-fold cross validation. Among all 314 landmarks (157 scans with two annotated landmarks), only 14 had a higher EUC error than 3.5 mm which equates to 95.5% SDR. For the clinically accepted SDR range of 3.5 mm, the invention outperforms other methods for both datasets by achieving 95.5% and 65% accuracy on the CCTA and ImageTBAD CTA datasets, respectively.

TABLE 1
Euclidean distance error (mm). Comparison between
the method of the invention and the three popular methods.

| | | CCTA dataset | | | | ImageTBAD CTA dataset | | | |
|---|---|---|---|---|---|---|---|---|---|
| Model | Landmarks | Median | Mean | Std | IQR | Median | Mean | Std | IQR |
| CNN (FC) | Left CA | 6.45 | 6.56 | 2.65 | 3.65 | 8.33 | 9.20 | 4.70 | 6.09 |
| | ostium | | | | | | | | |
| | Right CA | 6.58 | 7.2 | 4.36 | 4.58 | 10.03 | 11.05 | 6.20 | 8.16 |
| | ostium | | | | | | | | |
| Residual | Left CA | 4.85 | 5.23 | 2.40 | 2.97 | 9.07 | 9.16 | 4.87 | 5.45 |
| U-Net | ostium | | | | | | | | |
| (FC) | Right CA | 5.25 | 6.13 | 3.72 | 4.58 | 8.79 | 10.02 | 5.55 | 7.61 |
| | ostium | | | | | | | | |
| Residual | Left CA | 1.37 | 1.49 | 0.86 | 0.92 | 3.15 | 3.44 | 1.86 | 1.94 |
| U-Net | ostium | | | | | | | | |
| (Heatmaps) | Right CA | 1.29 | 1.65 | 1.67 | 0.90 | 2.82 | 3.16 | 1.78 | 2.23 |
| | ostium | | | | | | | | |
| Residual | Left CA | 1.11 | 1.32 | 0.93 | 0.76 | 2.66 | 3.19 | 2.06 | 2.40 |
| U-Net | ostium | | | | | | | | |
| (DSNT) | Right CA | 1.05 | 1.48 | 1.66 | 0.79 | 2.82 | 3.09 | 2.12 | 2.36 |
| | ostium | | | | | | | | |

### Ablation Study

The effect of a in the Jensen-Shannon divergence regularization [symbol] _{D} which controls the desired heatmap spread over the volume on the CCTA dataset was evaluated. See Table 2 for the results of evaluation. If a is too large, or too small, heatmaps are forced to be shaped to unnatural sizes. These results in heatmaps having too much or too little context and that affected the accuracy of prediction of ostium position. In the preferred embodiment, for σ=3 the best results were achieved.

Table 2: Euclidean distance error (mm). Ablation study of standard deviation parameter in heatmap generation from the ground truth for the CCTA dataset.

The method according to the invention outperforms other methods, achieving mean Euclidean distance error of 1.32 t 0.94 mm and 1.48±1.66 mm on left and right ostium respectively on the CCTA dataset and mean Euclidean distance error of 3.19±2.06 mm and 3.09±2.12 mm on left and right ostium respectively on the ImageTBAD CTA dataset. For the clinically accepted SDR range of 3.5 mm, the inventive method achieves 95.5% accuracy on the CCTA dataset and 65% accuracy on the ImageTBAD CTA dataset.

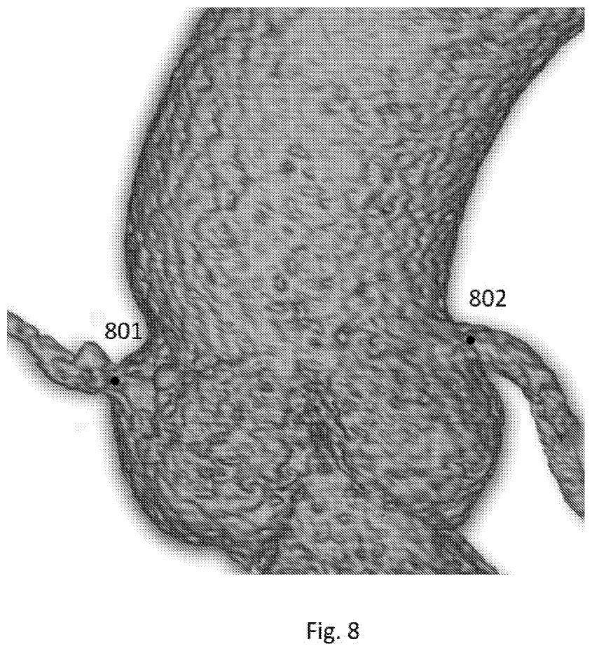

FIG. 8 illustrates a 3D rendering of a CCTA volume with left coronary ostium 801 and right coronary ostium 802. The invention was tested and evaluated on a CCTA dataset with 157 volumes and a CTA dataset with 77 volumes. FIG. 7 illustrates slices from two exemplary volumes from these datasets. Images 700, 710 and 720 are exemplary slices from the CCTA dataset in the sagittal, coronal and axial view, respectively. Points 701, 711 and 712 show position of a left coronary ostium. Images 730, 740 and 750 are exemplary slices from the CCTA dataset in the sagittal, coronal and axial view, respectively. Points 731, 741 and 752 show position of a left coronary ostium.

TABLE 2

| | | Median | Mean | Std | |
|---|---|---|---|---|---|
| Model | Landmark | [mm] | [mm] | [mm] | IQR |
| σ = 1 | Left CA ostium | 1.01 | 1.50 | 2.14 | 0.84 |
| | Right CA ostium | 1.16 | 1.68 | 2.56 | 0.9 |
| σ = 2 | Left CA ostium | 1.15 | 1.32 | 0.98 | 0.87 |
| | Right CA ostium | 0.96 | 1.54 | 2.6 | 0.86 |
| σ = 3 | Left CA ostium | 1.11 | 1.32 | 0.93 | 0.76 |
| | Right CA ostium | 1.05 | 1.48 | 1.66 | 0.79 |
| σ = 4 | Left CA ostium | 1.36 | 1.65 | 1.21 | 1.15 |
| | Right CA ostium | 1.07 | 1.67 | 2.07 | 0.95 |
| σ = 5 | Left CA ostium | 1.72 | 1.87 | 1.13 | 1.33 |
| | Right CA ostium | 1.20 | 1.69 | 1.77 | 1.08 |

### REFERENCES

[1] Al, W. A., Jung, H. Y., Yun, I. D., Jang, Y., Park, H. B., Chang, H. J.: Automatic aortic valve landmark localization in coronary ct angiography using colonial walk. PloS one 13(7), e0200317 (2018). [2] Dabbah, M. A., Murphy, S., Pello, H., Courbon, R., Beveridge, E., Wiseman, S., Wyeth, D., Poole, I.: Detection and location of 127 anatomical landmarks in diverse ct datasets. In: Medical Imaging 2014: Image Processing. vol. 9034, p. 903415. International Society for Optics and Photonics (2014). [3] Donner, R., Menze, B. H., Bischof, H., Langs, G.: Global localization of 3d anatomical structures by pre-filtered hough forests and discrete optimization. Medical image analysis 17(8), 1304-1314 (2013). [4] Elattar, M., Wiegerinck, E., van Kesteren, F., Dubois, L., Planken, N., Vanbavel, E., Baan, J., Marquering, H.: Automatic aortic root landmark detection in cta images for preprocedural planning of transcatheter aortic valve implantation. The international journal of cardiovascular imaging 32(3), 501-511 (2016). [5] Gao, Y., Shen, D.: Collaborative regression-based anatomical landmark detection. Physics in Medicine & Biology 60(24), 9377 (2015). [6] Han, D., Gao, Y., Wu, G., Yap, P. T., Shen, D.: Robust anatomical landmark detection for mr brain image registration. In: International Conference on Medical Image Computing and Computer-Assisted Intervention. pp. 186-193. Springer (2014). [7] Ibragimov, B., Likar, B., Pernus, F., Vrtovec, T.: Computerized cephalometry by game theory with shape- and appearance-based landmark refinement. In: Proceedings of International Symposium on Biomedical imaging (ISBI) (2015). [8] Ionasec, R. I., Georgescu, B., Gassner, E., Vogt, S., Kutter, O., Scheuering, M., Navab, N., Comaniciu, D.: Dynamic model-driven quantitative and visual evaluation of the aortic valve from 4d ct. In: International Conference on Medical Image Computing and Computer-Assisted Intervention. pp. 686-694. Springer (2008). [9] Jaderberg, M., Simonyan, K., Zisserman, A., et al.: Spatial transformer networks. Advances in neural information processing systems 28, 2017-2025 (2015). [10] Khanna, A., Londhe, N. D., Gupta, S., Semwal, A.: A deep residual u-net convolutional neural network for automated lung segmentation in computed tomography images. Biocybernetics and Biomedical Engineering 40(3), 1314-1327 (2020). [11] Lin, J.: Divergence measures based on the shannon entropy. IEEE Transactions on Information theory 37(1), 145-151 (1991). [12] Lu, X., Jolly, M. P.: Discriminative context modeling using auxiliary markers for lv landmark detection from a single mr image. In: International Workshop on Statistical Atlases and Computational Models of the Heart. pp. 105-114. Springer (2012). [13] Mahapatra, D.: Landmark detection in cardiac mri using learned local image statistics. In: International Workshop on Statistical Atlases and Computational Models of the Heart. pp. 115-124. Springer (2012). [14] Mostafa, A., Ghanem, A. M., El-Shatoury, M., Basha, T.: Improved centerline extraction in fully automated coronary ostium localization and centerline extraction framework using deep learning. In: 2021 43rd Annual International Conference of the IEEE Engineering in Medicine Biology Society (EMBC). pp. 3846-3849 (2021). [15] Newell, A., Yang, K., Deng, J.: Stacked hourglass networks for human pose estimation. In: European conference on computer vision. pp. 483-499. Springer (2016). [16] Nibali, A., He, Z., Morgan, S., Prendergast, L.: Numerical coordinate regression with convolutional neural networks. arXiv preprint arXiv:1801.07372 (2018). [17] Noothout, J. M., De Vos, B. D., Wolterink, J. M., Postma, E. M., Smeets, P. A., Takx, R. A., Leiner, T., Viergever, M. A., Išgum, I.: Deep learning-based regression and classification for automatic landmark localization in medical images. IEEE transactions on medical imaging 39(12), 4011-4022 (2020). [18] Noothout, J. M., de Vos, B. D., Wolterink, J. M., Leiner, T., Išgum, I.: Cnn-based landmark detection in cardiac cta scans. arXiv preprint arXiv:1804.04963 (2018). [19] Oktay, O., Bai, W., Guerrero, R, Rajchl, M., de Marvao, A., O'Regan, D. P., Cook, S. A., Heinrich, M. P., Glocker, B., Rueckert, D.: Stratified decision forests for accurate anatomical landmark localization in cardiac images. IEEE transactions on medical imaging 36(1), 332-342 (2016). [20] Payer, C., Štern, D., Bischof, H., Urschler, M.: Integrating spatial configuration into heatmap regression based cnns for landmark localization. Medical image analysis 54, 207-219 (2019). [21] Ronneberger, O., Fischer, P., Brox, T.: U-net: Convolutional networks for biomedical image segmentation. In: International Conference on Medical image computing and computer-assisted intervention. pp. 234-241. Springer (2015). [22] Štern, D., Ebner, T., Urschler, M.: From local to global random regression forests: exploring anatomical landmark localization. In: International Conference on Medical Image Computing and Computer-Assisted Intervention. pp. 221-229. Springer (2016). [23] Tompson, J. J., Jain, A., LeCun, Y., Bregler, C.: Joint training of a convolutional network and a graphical model for human pose estimation. Advances in neural information processing systems 27, 1799-1807 (2014). [24] Toshev, A., Szegedy, C.: Deeppose: Human pose estimation via deep neural networks. In: Proceedings of the IEEE conference on computer vision and pattern recognition. pp. 1653-1660 (2014). [25] Urschler, M., Ebner, T., Štern, D.: Integrating geometric configuration and appearance information into a unified framework for anatomical landmark localization. Medical image analysis 43, 23-36 (2018). [26] Wächter, I., Kneser, R., Korosoglou, G., Peters, J., Bakker, N., Weese, J., et al.: Patient specific models for planning and guidance of minimally invasive aortic valve implantation. In: International Conference on Medical Image Computing and Computer-Assisted Intervention. pp. 526-533. Springer (2010). [27] Wolterink, J. M., van Hamersvelt, R W., Viergever, M. A., Leiner, T., Išgum, I.: Coronary artery centerline extraction in cardiac ct angiography using a cnn-based orientation classifier. Medical image analysis 51, 46-60 (2019). [28] Yang, W., Li, S., Ouyang, W., Li, H., Wang, X.: Learning feature pyramids for human pose estimation. In: proceedings of the IEEE international conference on computer vision. pp. 1281-1290 (2017). [29] Yao, Z., Xie, W., Zhang, J., Dong, Y., Qiu, H., Yuan, H., Jia, Q., Wang, T., Shi, Y., Zhuang, J., et al.: Imagetbad: A 3d computed tomography angiography image dataset for automatic segmentation of type-b aortic dissection. Frontiers in Physiology 12 (2021). [30] Zhang, Z., Liu, Q., Wang, Y.: Road extraction by deep residual u-net. IEEE Geoscience and Remote Sensing Letters 15(5), 749-753 (2018). [31] Zheng, Y., John, M., Liao, R, Nottling, A., Boese, J., Kempfert, J., Walther, T., Brockmann, G., Comaniciu, D.: Automatic aorta segmentation and valve landmark detection in c-arm ct for transcatheter aortic valve implantation. IEEE transactions on medical imaging 31(12), 2307-2321 (2012). [32] He, Kaiming, et al. “Delving deep into rectifiers: Surpassing human-level performance on imagenet classification.” Proceedings of the IEEE international conference on computer vision. 2015. [33] Ioffe, Sergey, and Christian Szegedy. “Batch normalization: Accelerating deep network training by reducing internal covariate shift.” International conference on machine learning. PMLR, 2015. [34] Kingma, Diederik P., and Jimmy Ba. “Adam: A method for stochastic optimization.” arXiv preprint arXiv:1412.6980 (2014). [35] Wu, Yuxin, and Kaiming He. “Group normalization.” Proceedings of the European conference on computer vision (ECCV). 2018. [36] Ulyanov, Dmitry, Andrea Vedaldi, and Victor Lempitsky. “Instance normalization: The missing ingredient for fast stylization.” arXiv preprint arXiv:1607.08022 (2016). [37] Ba, Jimmy Lei, Jamie Ryan Kiros, and Geoffrey E. Hinton. “Layer normalization.” arXiv preprint arXiv:1607.06450 (2016).

Any calculation step or substep of the method according to the invention can be implemented using a computer or a computer program. In some specific embodiments, some or all calculations are done using a computer program stored on a computer or on any type of a memory device or both. In another embodiments, some or all calculations for the purpose of the method can be done remotely e.g., using cloud-based infrastructure which can include the use of Internet or a local network.

While all measurement methods and algorithms described here are intended to define the parameters of the invention and to provide tangible results to be compared with clinical trials, there are by no means limiting and are exemplary. The words like “including” or “comprising” are not limiting and, for example, when an element A includes another element B, the element A may include other element or elements in addition to the element B. The use of a singular or plural form is not limiting for the scope of the disclosure and, for example, a part of the description which is indicating that an element A contains an element B, this part also discloses that multiple elements B are contained in one element A and multiple elements A are contained in one element B as well as an embodiment where multiple elements A contain multiple elements B. Many other embodiments will be apparent and clear for those skilled in the art upon reviewing the content of the present disclosure. The scope of the invention, therefore, should be determined with reference to the appended claims along with the full scope of equivalents to which said claims are entitled to.

1. A method of detection of a landmark in a volume of medical images, wherein the method comprises generating at least one heatmap using a trained residual U-Net applied on the volume of medical images, wherein the volume of medical images comprises a computational tomography volume or a magnetic resonance volume, wherein the volume of medical images comprises voxels, wherein said at least one heatmap comprises a probability of finding localization of said landmark in voxels, wherein the residual U-Net comprises a contracting path and an expansive path, and wherein the contracting path comprises encoding residual blocks for encoding the volume of medical images and the expansive path comprises decoding residual blocks for decoding the volume of medical images encoded by the contracting path.

2. The method of claim 1, wherein the method additionally comprises transforming said at least one heatmap to coordinates of at least one landmark using a 3D Differentiable Spatial to Numerical Transform.

3. The method of any of claims 1-2, wherein the volume of medical images is a pre-processed volume of medical images.

4. The method of claim 3, wherein the re-processed volume of medical images is obtained using at least one of central cropping, clipping and setting values of selected voxels to defined values, normalizing the values of voxels and downsizing the volume of medical images and augmenting.

5. The method of claim 4, wherein said clipping and setting values of selected voxels to defined values comprises setting values of voxels smaller than −300 HU to −300 HU and setting values of voxels higher than 1100 HU to 1100 HU.

6. The method of claim 5, wherein said normalizing the values of voxels includes setting values of voxels equal −300 HU to 0, setting values of voxels equal 1100 HU to 1, and scaling linearly values between −300 HU and 1100 HU are set to a corresponding value in the scale from 0 to 1.

7. The method of any of claims 4-6, wherein said downsizing includes decreasing the volume of the volume of medical images 3 to 4 times.

8. The method of claim 7, wherein said downsizing includes decreasing the volume of the volume of medical images 3.1, 3.2, 3.3, 3.4, 3.5, 3.6, 3.7, 3.8 or 3.9 times.

9. The method of any of claims 4-8, wherein said augmenting includes rotation up to π/6 radians and translation up to 10 voxels in each dimension.

10. The method of any of claims 1-9, wherein encoding comprises downsampling of the volume of medical images and increasing the number of channels to produce a downsampled output and sending the downsampled output to a corresponding encoding residual block and to a corresponding decoding residual block.

11. The method of claim 10, wherein downsampling is done by a factor of two.

12. The method of any of claims 1-11, wherein decoding comprises upsampling of an input to a residual decoding block of the volume of medical images to produce an upsampled output with a decreased number of channels.

13. The method of claim 12, wherein upsampling is done by a factor of two.

14. The method of any of claims 1-13, wherein training of the trained residual U-Net comprises at least one of:
minimization of the divergence between said at least one heatmap and an annotated heatmap comprising at least one annotation, wherein said at least annotation points to localization of the landmark on said at least one heatmap, and
minimization of the Euclidean distance between the localization on said at least one heatmap and the localization on the heatmap comprising at least one annotation.

15. The method of any of claims 1-14, wherein the probability of finding the landmark has a normal distribution.

16. The method of any of claims 14-15, wherein said minimization of the Euclidean distance includes [symbol] _{E}(ŷ,y)=∥ŷ−y∥₂ and said minimization of the divergence includes [symbol] _{D}(Ĥ,y)=D_{JS} (Ĥ∥ [symbol] (y,σ²)), where D_{JS}(·∥·) is the Jensen-Shannon divergence, Ĥ is the heatmap generated by the residual U-Net and normalized b normalization function, y is the expected localization, ŷ is the predicted localization, and [symbol] (y,σ²) is the expected heatmap generated by sampling from the normal distribution [symbol] with standard deviation σ around expected localization y.

17. The method of claim 16, wherein a is equal 3.

18. The method of any of claims 14-17, wherein training of the trained residual U-Net includes a linear combination of said minimization of the divergence and said minimization of the Euclidean distance: [symbol] (Ĥ,y)= [symbol] _{E}(DSNT(Ĥ),y)+λ [symbol] _{D}(Ĥ,y)= [symbol] _{E}(ŷ,y)+λL_{D}(Ĥ,y),
where λ is a regularization coefficient hyperparameter.

19. The method of claim 18, wherein λ is equal 1.

20. The method of any of claims 14-19, wherein said at least one heatmap and said annotated heatmap are produced using the same volume of medical images or using a different volumes.

21. The method of any of claims 1-20, wherein the 3D Differentiable Spatial to Numerical Transform includes:
DSNT(Ĥ)=[ [symbol] Ĥ,X [symbol] _{F}, [symbol] Ĥ,Y [symbol] _{F}, [symbol] Ĥ,Z [symbol] _{F}],
where Ĥ=φ(H), and Ĥ is the heatmap H output from the residual U-Net and normalized by a normalization function, wherein <·, ·>_{F} represents a Frobenius inner product of two matrices, wherein said two matrices are selected from Ĥ, X, Y and Z, and wherein
X, Y and Z are grids in the form of m×n×l matrices defined as:
$${X}_{i , j , k} = \frac{2 j - ( n + 1 )}{n} , {Y}_{i , j , k} = \frac{2 i - ( m + 1 )}{m} , {Z}_{i , j , k} = \frac{2 k - ( l + 1 )}{l} .$$

22. The method of any of claims 1-21, wherein each encoding residual block comprises: a first encoding convolution layer for receiving an encoding residual block input, a first encoding norm layer for receiving output from the first encoding convolution layer, a first encoding activation layer for receiving output from the first encoding norm layer, a second encoding convolution layer for receiving output from the first encoding activation layer, a second norm layer for receiving output from the second encoding convolution layer, a second encoding activation layer for receiving output from the second encoding norm layer, and a subsequent encoding convolution layer for receiving the encoding residual block input, and
wherein the subsequent encoding convolution layer contains a 3D matrix of size 3×3×3 or 1×1×1, wherein the second encoding convolution layer contains a 3D matrix of size 3×3×3 and the first encoding convolution layer contains a 3D matrix of size 3×3×3,
wherein output from the subsequent encoding convolution layer has greater number of channel than the encoding residual block input, wherein the output from the first encoding convolution layer has greater number of channel than the encoding residual block input,
wherein an output from the subsequent convolution encoding layer and from the second encoding activation layer is merged by regular matrix addition,
wherein the first encoding convolution layer and the subsequent encoding convolution layer comprises a strided 3D convolution operator, wherein the strided 3D convolution operator comprises:
$$K {★}_{S} I = {\sum }_{p = 1}^{S} {\sum }_{q = 1}^{S} {\sum }_{r = 1}^{S} {K}_{p , q , r} ★ {I}_{p , q , r} ,$$
where K is a kernel comprising a 3D matrix, I is an example input volume, and s is the stride, and
wherein the first encoding norm activation and the second encoding activation layer comprise an activation function, wherein said activation function is selected from tanh, a Rectified Linear Unit or a Parametric Rectified Linear Unit, wherein the Parametric Rectified Linear Unit comprises:
$$\begin{matrix}f ( {y}_{i} ) = {y}_{i} if {y}_{i} \geq 0 , \\ f ( {y}_{i} ) = {α}_{i} {y}_{i} if {y}_{i} < 0\end{matrix}$$
wherein yᵢ is the i-th element of the input volume y, and a is a learnable parameter, and
wherein the first encoding norm layer and the second encoding norm layer include a Batch normalization, an instance normalization, a layer normalization or a 3D Batch Normalization, and wherein the 3D Batch Normalization includes:
$$y = \frac{x - E [ x ]}{\sqrt{Var [ x ] + ϵ}} \cdot γ + β ,$$
where x is the input, and y output of the Batch Normalization layer; γ and β are learnable parameters and ϵ is a small constant value added to the denominator for numerical stability.

23. The method of any of claims 1-22, wherein each decoding residual block comprises:
a first decoding convolution layer for receiving a decoding residual block input, comprising a 3D cross-correlation operator and a 3D matrix of size 1×1×1, a decoding upsample layer for receiving output of the first decoding convolution layer, wherein the decoding upsample layer is configured to upsample the output of the first decoding convolution layer spatially by the factor of two using nearest neighbor interpolation, a first decoding norm layer for receiving output of the decoding upsample layer, a first activation layer for receiving output of the first decoding norm layer, a second decoding convolution layer for receiving output of the first activation layer, wherein the second decoding convolution layer comprises a kernel comprising a 3D matrix of size 3×3×3, a second decoding norm layer for receiving output of the second decoding convolution layer, a second decoding activation layer for receiving output of the second decoding norm layer, and
wherein the 3D cross-correlation operator comprises:
$$K ★ I ( x , y , z ) = {\sum }_{i = - N}^{N} {\sum }_{j = - N}^{N} {\sum }_{l = - N}^{N} K ( i , j , l ) \times I ( x + i , y + j , z + l ) ,$$
where K is a kernel comprising a 3D matrix of size N×N×N, and I(x,y,z) is a voxel of an example input volume I of coordinates x,y,z,
wherein the first decoding norm layer and the second decoding norm layer include a Batch normalization, an instance normalization, a layer normalization or a 3D Batch Normalization, and wherein the 3D Batch Normalization includes:
$$y = \frac{x - E [ x ]}{\sqrt{Var [ x ] + ϵ}} \cdot γ + β ,$$
where x is the input, and y output of the Batch Normalization layer; γ and β are learnable parameters and ϵ is a small constant value added to the denominator for numerical stability, and
wherein the first decoding activation layer and the second decoding activation layer comprise an activation function, wherein said activation function is selected from tanh, a Rectified Linear Unit or a Parametric Rectified Linear Unit, wherein the Parametric Rectified Linear Unit comprises:
$$\begin{matrix}f ( {y}_{i} ) = {y}_{i} if {y}_{i} \geq 0 , \\ f ( {y}_{i} ) = {α}_{i} {y}_{i} if {y}_{i} < 0\end{matrix}$$
wherein yᵢ is the i-th element of the input volume y, and a is a learnable parameter.

24. The method of any of claims 22-23, wherein each residual block comprises:
$$\begin{matrix}{y}_{l} = h ( {x}_{l} ) + ℱ ( {x}_{l} , {W}_{l} ) , \\ {x}_{l + 1} = f ( {y}_{l} )\end{matrix}$$
where xₗ and xₗ₊₁ are the input and output of the l-th residual block, [symbol] (·) is a residual function, ƒ (yᵢ) is an activation function and h(xᵢ) is an identity mapping function,
wherein for each encoding residual block the residual function comprises the first encoding convolution layer, the first encoding norm layer, the first encoding activation layer, the second encoding convolution layer, the second norm layer, and the second encoding activation layer, and
wherein for each decoding residual block the residual function comprises the second decoding convolution layer, the second decoding norm layer and the second decoding activation layer.

25. The method of claim 24, wherein for each encoding residual block:
$$h ( {x}_{l} ) = {\sum }_{c = 0}^{{C}_{i n} - 1} ( \begin{matrix}{K}_{{C}_{out} , c} & {★}_{s} & {x}_{{l}_{c}}\end{matrix} ) ,$$
where * is a 3D cross-correlation operator or a strided 3D cross-correlation operator; Cᵢₙ is the number of input channels; Cₒᵤₜ is the number of output channels; K is a set of learnable weights in the form of convolution kernels; and s is the stride value, wherein the 3D cross-correlation operator comprises:
$$K ★ I ( x , y , z ) = {\sum }_{i = - N}^{N} {\sum }_{j = - N}^{N} {\sum }_{l = - N}^{N} K ( i , j , l ) \times I ( x + i , y + j , z + l ) ,$$
where K is a kernel comprising a 3D matrix of size N×N×N, and I(x,y,z) is a voxel of an example input volume I of coordinates x,y,z.

26. The method of any of claims 22-25, wherein for each decoding residual block h(xₗ)=xₗ.

27. The method of any of claims 1-26, wherein said at least one landmark is selected from the list comprising inlets and outlets surrounding ostium of Left Coronary Artery, inlets and outlets surrounding ostium of Right Coronary Artery, apex of left ventricle, base/basis of left ventricle, 17 segments of left ventricle according to American Heart Association, junction points of left and right ventricles, ostium LCA ostium of Left Coronary Artery, ostium RCA ostium of Right Coronary Artery, LM division of Left Main Coronary Artery, DG1 origin of 1st diagonal artery, DG2 origin of 2st diagonal artery origin of ramus intermedius artery, OM1 origin of 1st obtuse marginal artery, OM2 origin of 2st obtuse marginal artery, RCA origin of Right Coronary Artery, AM origin of Acute Marginal Branch, PDA origin of Posterior Descending Artery, PL origin of Posterior Left Ventricular Artery, inlet of Superior Vena Cava to right atrium, inlet of Inferior Vena Cava to right atrium, inlet of coronary sinus to right atrium, inlet of right appendage/auricle to right atrium, apex of right appendage/auricle, inlet of left superior/inferior and right superior/inferior pulmonary veins to left atrium, inlet of right appendage/auricle to right atrium, apex of left appendage/auricle, origin of pulmonary trunk, tricuspid valve including leaflets: anterior, posterior and septal, apex of Right Ventricle, origin of ascending aorta, aortic valve including leaflets: right, left, posterior anterior, right anterior, right posterior, anterior coronary, left coronary, right coronary, non-coronary, bicuspid valve including leaflets: anterior and posterior, mitral valve including leaflets: anterior and posterior, ANTETIOR CEREBRAL ARTERY, landmarks located at the beginning of horizontal or pre-communicating segment, vertical, post-communicating or infracallosal segment, precallosal segment, supracallosal segment, postcallosal segment, ANTERIOR COMMUNICATING ARTERY, SUPERIOR CEREBELLAR ARTERY, ANTERIOR INFERIOR CEREBELLAR ARTERY, POSTERIOR INFERIOR CEREBELLAR ARTERY, MIDDLE CEREBRAL ARTERY, landmarks located at the beginning of sphenoidal/horizontal segment, insular segment, opercular segment, cortial segment, POSTERIOR CEREBRAL ARTERY, landmarks located at the beginning of pre-communicating segment, post-communicating segment, quadrigeminal segment, cortical segment, POSTERIOR COMMUNICATING ARTERY, OPHTALMIC ARTERY, RIGHT AND LEFT CHOROIDAL ARTERY, BASILAR ARTERY, ANTERIOR SPINAL ARTERY, BRACHIOCEPHALIC ARTERY/TRUNK, RIGHT/LEFT SUBCLAVIAN ARTERY, RIGHT/LEFT COMMON CAROTID ARTERY, RIGHT/LEFT INTERNAL CAROTID ARTERY, RIGHT/LEFT EXTERNAL CAROTID ARTERY, RIGHT/LEFT VERTEBRAL ARTERY, RIGHT/LEFT THYROCERVICAL TRUNK, RIGHT/LEFT INTERNAL THORACIC ARTERY, RIGHT/LEFT COSTOCERVICAL TRUNK, RIGHT/LEFT SUPRASCAPULAR ARTERY, RIGHT/LEFT TRANSVERSE CERVICAL ARTERY, RIGHT/LEFT AXILLARY ARTERY, RIGHT/LEFT BRACHIUAL ARTERY, RIGHT/LEFT ULNAR ARTERY, RIGHT/LEFT RADIAL ARTERY, RIGHT/LEFT SUPERIOR THYROID ARTERY, RIGHT/LEFT LINGUAL ARTERY, RIGHT/LEFT FACIAL ARTERY, RIGHT/LEFT ASCENDING PHARYNGEAL ARTERY, RIGHT/LEFT OCCIPITAL ARTERY, RIGHT/LEFT POSTERIOR AURICULAR ARTERY, RIGHT/LEFT SUPERFICIAL TEMPORAL ARTERY, RIGHT/LEFT MAXILLARY ARTERY, POSTERIOR INTERCOSTAL ARTERIES, SUBCOSTAL ARTERIES, SUPERIOR PHRENIC ARTERIES, PERICARDIAL ARTERIES, OESOPHAGAL ARTERIES, ESOPHAGEAL BRANCHES OF INFERIOR THYROID ARTERY (TOP THIRD), ESOPHAGEAL BRANCHES OF THORACIC PART OF AORTA (MIDDLE THIRD), ESOPHAGEAL BRANCHES OF LEFT GASTRIC ARTERY (BOTTOM THIRD), LOWER DIAPHRAGMATIC ARTERIES, LUMBAR ARTERIES, CELIAC TRUNK, SUPERIOR MESENTRIC ARTERY, INFERIOR MESENTRIC ARTERY, MIDDLE SUPRARENAL ARTERY, RENAL ARTERIES, TESTICULAR ARTERY/INTERNAL SPERMATIC ARTERY/OVARIAN ARTERY, COMMON ILIAC ARTERIES, INTERNAL ILIAC ARTERIES, EXTERNAL ILIAC ARTERIES, FEMORAL ARTERIES, POPLITEAL ARTERIES, ANTERIOR TIBIAL ARTERIES, DORSAL ARTERIES OF FOOT, POSTERIOR TIBIAL ARTERIES, MEDIAL PLANTAR ARTERIES, LATERAL PLANTAR ARTERIES, V. CAVA SUPERIOR, VV. BRACHIOCEPHALICAE, V. SUBCLAVIA, VV. IUGULARES, V. CAVA INFERIOR, VV. ILIACAE COMMUNES, V. ILIACA EXTERNA, V. ILIACA INTERNA, VV. CORDIS, V. CARDIACA MAGNA, V. CARDIACA PARVA, V. CARDIACA MEDIA, V. POSTERIOR VENTRICULI SINISTRI, V. OBLIQUA ATRII SINISTRI, VV. CARDIACAE ANTERIORES, V. MARGINALIS DEXTRA, V. MARGINALIS SINISTRA, VV. CARDIACAE MINIMAE, VV. CEREBRI, V. CEREBRI INTERNA, V. SEPTI PELLUCIDI ANTERIOR, V. SEPTI PELLUCIDI POSTERIOR, V. THALAMOSTRIATA SUPERIOR, VV. THALAMOSTRIATAE INFERIORES, V. CHOROIDEA SUPERIOR, V. CHOROIDEA INFERIOR, V. CEREBRI MAGNA, VV. CEREBRI SUPERIORES, VV. CEREBRI INFERIORES, V. CEREBRI ANTERIOR, V. CEREBRI MEDIA PROFUNDA, V. CEREBRI MEDIA SUPERFICIALIS, VV. ANASTOMOTICAE, V. ANASTOMOTICA SUPERIOR, V. ANASTOMOTICA INFERIOR, V. BASALIS, V. COMMUNICANS ANTERIOR, V. COMMUNICANS POSTERIOR, CIRCULUS VENOSUS CEREBRI, V. COMMUNICANS POSTERIOR, V. SUPERIOR VERMIS, VV. HEMISPHAERII CEREBELLI SUPERIORES, V. VERMIS INFERIOR, VV. HEMISPHAERII CEREBELLI INFERIORES, VV. DIPLOICAE, V. DIPLOICA FRONTALIS, V. DIPLOICA TEMPORALIS ANTERIOR, V. DIPLOICA TEMPORALIS POSTERIOR, V. DIPLOICA OCCIPITALIS, VV. EMISSARIAE, V. EMISSARIA PARIETALIS, V. EMISSARIA MASTOIDEA, V. EMISSARIA CONDYLARIS, V. EMISSARIA OCCIPITALIS, PLEXUS VENOSUS FORAMINIS OVALIS, PLEXUS VENOSUS CAROTICUS INTERNUS, PLEXUS VENOSUS CANALIS HYPOGLOSSI, VV. MENINGEAE, VV. MENINGEAE MEDIAE, SINUS DURAE MATRIS, SINUS SAGITTALIS SUPERIOR, SINUS SAGITTALIS INFERIOR, SINUS RECTUS, SINUS TRANSVERSUS, SINUS SIGMOIDEUS, SINUS OCCIPITALIS, CONFLUENS SINUUM, SINUS CAVERNOSUS, SINUS INTERCAVERNOSI, PLEXUS BASILARIS, V. OPHTHALMICA SUPERIOR, V. LACRIMALIS, VV. ETHMOIDALES, ANTERIOR ET POSTERIOR, V. NASOFRONTALIS, V. OPHTHALMICA INFERIOR, V. FACIALIS, V. ANGULARIS, V. SUPRATROCHLEARIS, V. SUPRAORBITALIS, VV. PALPEBRALES, VV. NASALES EXTERNAE, VV. LABIALES, V. PROFUNDA FACIEI, RAMI PAROTIDEI, V. SUBMENTALIS, V. PALATINA EXTERNA, V. RETROMANDIBULARIS, VV. TEMPORALES SUPERFICIALES, V. TEMPORALIS MEDIA, V. TRANSVERSA FACIEI, VV. ARTICULARES, V. STYLOMASTOIDEA, VV. AURICULARES ANTERIORES, VV. PAROTIDEAE, VV. MAXILLARES, V. IUGULARIS EXTERNA, V. AURICULARIS POSTERIOR, V. OCCIPITALIS, V. SUPRASCAPULARIS, VV. TRANSVERSAE COLLI, V. IUGULARIS ANTERIOR, PLEXUS PTERYGOIDEUS, V. SPHENOPALATINA, VV. MENINGEAE MEDIAE, VV. TEMPORALES PROFUNDAE, VV. ALVEOLARES SUP., VV. MASSETERICAE, V. ALVEOLARIS INFERIOR, V. VERTEBRALIS, V. VERTEBRALIS ANTERIOR, V. CERVICALIS PROFUNDA, V. IUGULARIS INTERNA, SINUS SIGMOIDEUS, SINUS OCCIPITALIS, PLEXUS VENOSUS CANALIS HYPOGLOSSI, V. CANALICULI COCHLEAE, SINUS PETROSUS INFERIOR, V. OCCIPITALIS, V. FACIALIS, VV. PHARYNGEALES, V. LINGUALIS, V. PROFUNDA LINGUAGE, VV. DORSALES LINGUAE, V. COMITANS N. HYPOGLOSSI, VV. THYROIDEAE SUPERIORES, VV. SUBFASCIALES, ARCUS VENOSUS PALMARIS PROFUNDUS, VV. RADIALES, VV. ULNARES, VV. BRACHIALES, V. BRACHIALIS COMMUNIS, V. BASILICA, VV. MUSCULUS, VV. COLATERALIS ULNAE, V PROFUNDA BRACHII, V. AXILLARIS, V. SUBCLAVIA, VV. CUTANEAE, VV. DIGITORUM, V. INTERCAPITALIS, ARCUS VENOSUS DIGITALIS PALMARIS, V. INTERDIGITALIS, ARCUS VENOSUS DIGITALIS DORSALIS, RETE VENOSUM DORSALE MANUS, VV. METACARPALES DORSALES, ARCUS VENOSUS METACARPALIS DORSALIS, VV. MARGINALES, V. SALVATELLA, V. CEPHALICA POLLICIS, V. CEPHALICA, V. CEPHALICA ANTEBRACHII, V. CEPHALICA ACCESSORIA, V. INTERMEDIA CUBITI, V. BASILICA, V. INTERMEDIA ANTEBRACHII, V. INTERMEDIA BASILICA, V. INTERMEDIA CEPHALICA, V. CAVA SUPERIOR, V. BRACHIOCEPHALICA, ANGULUS VENOSUS, V. THYROIDEA INFERIOR, VV. THYROIDEAE IMAE, V. VERTEBRALIS, V. CERVICALIS PROFUNDA, V. IUGULARIS EXT., VV. PERICARDIACOPHRENICAE, VV. THYMICAE, VV. PERICARDIALES, VV. MEDIASTINALES, VV. BRONCHIALES, VV. TRACHEALES, VV. ESOPHAGEALES, VV. THORACICAE INTERNAE, VV. MUSCULOPHRENICAE, VV. EPIGASTRICAE SUPERIORES, VV. INTERCOSTALES ANTERIORES, RAMI PERFORANTES, RAMI STERNALES, V. INTERCOSTALIS SUPERIOR, VV. CUTANEAE ABDOMINIS ET PECTORIS, PLEXUS VENOSUS AREOLARIS, VV. THORACOEPIGASTRICAE, VV. COSTOAXILLARES, V. AZYGOS, V. HEMIAZYGOS, PLEXUS VENOSI VERTEBRALES EXTERNI, PLEXUS VENOSI VERTEBRALES INTERNI, VV. BASIVERTEBRALES, VV. INTERVERTEBRALES, VV. SPINALES, VV. SPINALES INTERNAE, VV. SPINALES EXTERNAE, VV. RADICULARES, VV. DORSALES PEDIS, VV. PLANTARES LATERALES, ARCUS VENOSUS PLANTARIS, VV. PLANTARES MEDIALES, VV. METATARSALES PLANTARES, VV. PERFORANTES, VV. TIBIALES ANTERIORES, VV. TIBIALES POSTERIORES, VV. FIBULARES S. PERONEALES, V. POPLITEA, VV. GENICULARES, VV. SURALES, V. SAPHENA PARVA, V. FEMORALIS, V. EPIGASTRICA SUPERFICIALIS, V. CIRCUMFLEXA ILIACA SUPERFICIALIS, VV. THORACOEPIGASTRICAE, VV. PUDENDAE EXTERNAE: VV. SCROTALES ANTERIORES, VV. LABIALES ANTERIORES, VV. DORSALES SUPERFICIALES PENIS, VV. DORSALES SUPERFICIALES CLITORIDIS, V. SAPHENA MAGNA, V. PROFUNDA FEMORIS, VV. PERFORANTES, VV. CRICUMFLEXAE MEDIALES FEMORIS, VV. CRICUMFLEXAE LATERALES FEMORIS, VV. GLUTEAE SUPERIORES, VV. GLUTEAE INFERIORES, VV. DIGITALES DORSALES, VV. INTERCAPITALES, VV. METATARSALES DORSALES, ARCUS VENOSUS DORSALIS PEDIS, VV. DIGITALES PLANTARES, ARCUS VENOSUS PLANTARIS, RETE VENOSUM PLANTARE, RETE VENOSUM DORSALE, V. SAPHENA, V. SAPHENA PARVA, V. CAVA INFERIOR, VV. PHRENICAE INFERIORES, VV. LUMBALES, VV. HEPATICAE, VV. RENALES, V. SUPRARENALIS, V. TESTICULARIS, V. OVARICA, VV. ILIACAE COMMUNES, V. SACRALIS MEDIANA, V. ILIACA EXTERNA, V. CIRCUMFLEXA ILIACA PROFUNDA, V. EPIGASTRICA INFERIOR, V. ILIACA INTERNA, V. ILIOLUMBALIS, VV. SACRALES LATERALES, VV. GLUTEAE SUPERIORES, VV. GLUTEAE INFERIORES, VV. OBTURATORIAE, V. PUDENDA INTERNA, VV. PROFUNDAE PENIS RESP. CLITORIDIS, VV. BULBI PENIS RESP. VV. BULBI VESTIBULI VAGINAE, VV. SCROTALES POSTERIORES RESP. LABIALES POSTERIORES, VV. RECTALES INFERIORES, V. DORSALIS PENIS, VV. CRICUMFLEXAE PENIS, V. DORSALIS CLITORIDIS, VV. DORSALES PENIS SUPERFICIALES, VV. DORSALES CLITORIDIS SUPERFICIALES, PLEXUS VENOSUS RECTALIS, PLEXUS VENOSUS VESICALIS, PLEXUS VENOSUS PROSTATICUS, PLEXUS VENOSUS UTERINUS, PLEXUS VENOSUS VAGINALIS, V. PORTAE HEPATIS, V. MESENTERICA SUPERIOR, VV. IEIUNALES ET ILEALES, V. ILEOCOLICA, V. APPENDICULARIS, V. COLICA DEXTRA, VV. PANCREATICAE, V. GASTROOMENTALIS DEXTRA, V. PANCREATICODUODENALIS INF., V. SPLENICA S. LIENALIS, VV. PANCREATICAE, VV. GASTRICAE BREVES, V. GASTROOMENTALIS SINISTRA, V. MESENTERICA INFERIOR, VV. SIGMOIDEAE, V. COLICA SIN., V. RECTALIS SUP., V. GASTRICA SINISTRA, V. GASTRICA DEXTRA, V. PREPYROLICA, V. PANCREATICODUODENALIS SUPERIOR POSTERIOR, V. CYSTICA, V. UMBILICALIS, major duodenal papilla/papilla of Vater, inlet of cystic duct to common biliary duct, outlet of cystic duct from gallbladder, junction of right and left hepatic duct, junction of right anterior and right posterior hepatic duct, carina, subdivision to right superior lobar bronchus, subdivision to right middle lobar bronchus, subdivision to right inferior lobar bronchus, subdivision to left superior lobar bronchus, subdivision to left inferior lobar bronchus, subdivision to right first segmental bronchus, subdivision to right second segmental bronchus, subdivision to right third segmental bronchus, subdivision to right fourth segmental bronchus, subdivision to right fifth segmental bronchus, subdivision to right sixth segmental bronchus, subdivision to right seventh segmental bronchus, subdivision to right eight segmental bronchus, subdivision to right ninth segmental bronchus, subdivision to right tenth segmental bronchus, subdivision to right first segmental bronchus, subdivision to left first segmental bronchus, subdivision to left second segmental bronchus, subdivision to left third segmental bronchus, subdivision to left fourth segmental bronchus, subdivision to left fifth segmental bronchus, subdivision to left sixth segmental bronchus, subdivision to left seventh segmental bronchus, subdivision to left eighth segmental bronchus, anterior nares, outlet/drainage of right posterior ethmoidal cells to right sphenoethmoidal recess, outlet/drainage of left posterior ethmoidal cells to left sphenoethmoidal recess, outlet/drainage of right sphenoid sinus to right spheno-ethmoidal recess, outlet/drainage of right sphenoethmoidal recess to right superior nasal meatus, outlet/drainage of left sphenoethmoidal recess to left superior nasal meatus, outlet/drainage of right frontal sinus to right frontal recess, outlet/drainage of left frontal sinus to left frontal recess, outlet/drainage of right frontal recess to right middle nasal meatus, outlet/drainage of left frontal recess to left middle nasal meatus, outlet/drainage of right frontal ethmoidal cells to right ostiomeatal complex, outlet/drainage of right frontal ethmoidal cells to right ostiomeatal complex, outlet/drainage of right maxillary sinus to right ostiomeatal complex, outlet/drainage of left maxillary sinus to left ostiomeatal complex, outlet/drainage of right ostiomeatal complex to right middle nasal meatus, outlet/drainage of left ostiomeatal complex to left middle nasal meatus, outlet/drainage of right nasolacrimal duct to right inferior nasal meatus, outlet/drainage of left nasolacrimal duct to left inferior nasal meatus, postrior nares/posterior nasal aperture/chonoae, uvula, pharyngeal tonsil, opening of left and right auditory tube, tip of epiglottis, right and left piriform recess/fossa/sinus, postcricoid region, cricoid cartillage, interarytenoid fold, right and left aryepiglottic fold, right and left arytenoid cartillages, right and left vesibular fold, outlet of right and left laryngeal sacc, vocal chords, right and left vocal fold, first tracheal cartillage, Kidneys, Renal papilla, Minor calyxes, Renal pyramids, Renal pelvis, inlet ureter, Abdominal aortic plexus, Abducens nerves, Accessory nerve, Accessory obturator nerve, Alderman's nerve, Anococcygeal nerve, Ansa cervicalis, Anterior interosseous nerve, Anterior superior alveolar nerve, Auerbach's plexus, Auriculotemporal nerve, Axillary nerve, Brachial plexus, Buccal branch of the facial nerve, Buccal nerve, Cardiac plexus, Cavernous nerves, Cavernous plexus, Celiac ganglia, Cervical branch of the facial nerve, Cervical plexus, Chorda tympani, Ciliary ganglion, Coccygeal nerve, Cochlear nerve, Common fibular nerve, Common palmar digital nerves of median nerve, Deep branch of the radial nerve, Deep fibular nerve, Deep petrosal nerve, Deep temporal nerves, Diagonal band of Broca, Digastric branch of facial nerve, Dorsal branch of ulnar nerve, Dorsal nerve of clitoris, Dorsal nerve of the penis, Dorsal scapular nerve, Esophageal plexus, Ethmoidal nerves, External laryngeal nerve, External nasal nerve, Facial nerve, Femoral nerve, Frontal nerve, Gastric plexuses, Geniculate ganglion, Genital branch of genitofemoral nerve, Genitofemoral nerve, Glossopharyngeal nerve, Greater auricular nerve, Greater occipital nerve, Greater petrosal nerve, Hepatic plexus, Hypoglossal nerve, Iliohypogastric nerve, Ilioinguinal nerve, Inferior alveolar nerve, Inferior anal nerves, Inferior cardiac nerve, Inferior cervical ganglion, Inferior gluteal nerve, Inferior hypogastric plexus, Inferior mesenteric plexus, Inferior palpebral nerve, Infraorbital nerve, Infraorbital plexus, Infratrochlear nerve, Intercostal nerves, Intercostobrachial nerve, Intermediate cutaneous nerve, Internal carotid plexus, Internal laryngeal nerve, Interneuron, Jugular ganglion, Lacrimal nerve, Lateral cord, Lateral cutaneous nerve of forearm, Lateral cutaneous nerve of thigh, Lateral pectoral nerve, Lateral plantar nerve, Lateral pterygoid nerve, Lesser occipital nerve, Lingual nerve, Long ciliary nerves, Long root of the ciliary ganglion, Long thoracic nerve, Lower subscapular nerve, Lumbar nerves, Lumbar plexus, Lumbar splanchnic nerves, Lumboinguinal nerve, Lumbosacral plexus, Lumbosacral trunk, Mandibular nerve, Marginal mandibular branch of facial nerve, Masseteric nerve, Maxillary nerve, Medial cord, Medial cutaneous nerve of arm, Medial cutaneous nerve of forearm, Medial cutaneous nerve, Medial pectoral nerve, Medial plantar nerve, Medial pterygoid nerve, Median nerve, Meissner's plexus, Mental nerve, Middle cardiac nerve, Middle cervical ganglion, Middle meningeal nerve, Motor nerve, Muscular branches of the radial nerve, Musculocutaneous nerve, Mylohyoid nerve, Nasociliary nerve, Nasopalatine nerve, Nerve of pterygoid canal, Nerve to obturator internus, Nerve to quadratus femoris, Nerve to the Piriformis, Nerve to the stapedius, Nerve to the subclavius, Nervus intermedius, Nervus spinosus, Nodose ganglion, Obturator nerve, Oculomotor nerve, Olfactory nerve, Ophthalmic nerve, Optic nerve, Otic ganglion, Ovarian plexus, Palatine nerves, Palmar branch of the median nerve, Palmar branch of ulnar nerve, Pancreatic plexus, Patellar plexus, Pelvic splanchnic nerves, Perforating cutaneous nerve, Perineal branches of posterior femoral cutaneous nerve, Perineal nerve, Petrous ganglion, Pharyngeal branch of vagus nerve, Pharyngeal branches of glossopharyngeal nerve, Pharyngeal nerve, Pharyngeal plexus, Phrenic nerve, Phrenic plexus, Posterior auricular nerve, Posterior branch of spinal nerve, Posterior cord, Posterior cutaneous nerve of arm, Posterior cutaneous nerve of forearm, Posterior cutaneous nerve of thigh, Posterior scrotal nerves, Posterior superior alveolar nerve, Proper palmar digital nerves of median nerve, Prostatic plexus (nervous), Pterygopalatine ganglion, Pudendal nerve, Pudendal plexus, Pulmonary branches of vagus nerve, Radial nerve, Recurrent laryngeal nerve, Renal plexus, Sacral plexus, Sacral splanchnic nerves, Saphenous nerve, Sciatic nerve, Semilunar ganglion, Sensory nerve, Short ciliary nerves, Sphenopalatine nerves, Splenic plexus, Stylohyoid branch of facial nerve, Subcostal nerve, Submandibular ganglion, Suboccipital nerve, Superficial branch of the radial nerve, Superficial fibular nerve, Superior cardiac nerve, Superior cervical ganglion, Superior ganglion of glossopharyngeal nerve, Superior ganglion of vagus nerve, Superior gluteal nerve, Superior hypogastric plexus, Superior labial nerve, Superior laryngeal nerve, Superior lateral cutaneous nerve of arm, Superior mesenteric plexus, Superior rectal plexus, Supraclavicular nerves, Supraorbital nerve, Suprarenal plexus, Suprascapular nerve, Supratrochlear nerve, Sural nerve, Sympathetic trunk, Temporal branches of the facial nerve, Third occipital nerve, Thoracic aortic plexus, Thoracic splanchnic nerves, Thoraco-abdominal nerves, Thoracodorsal nerve, Tibial nerve, Transverse cervical nerve, Trigeminal nerve, Trochlear nerve, Tympanic nerve, Ulnar nerve, Upper subscapular nerve, Uterovaginal plexus, Vagus nerve, Ventral ramus, Vesical nervous plexus, Vestibular nerve, Vestibulocochlear nerve, Zygomatic branches of facial nerve, Zygomatic nerve, Zygomaticofacial nerve, Zygomaticotemporal nerve, Foramen caecum, Optic canal, Superior orbital fissure, Foramen rotundum, Foramen ovale, Foramen spinosum, Foramen lacerum, Carotid canal, Internal acoustic foramen, Jugular foramen, Hypoglossal canal, and Foramen magnum.

28. A computer-readable medium comprising instructions which, when executed by a computer, cause the computer to carry the steps of a method defined in any of claims 1-27.

29. A system for detection of a landmark in a volume of medical images, wherein the system comprises:
a measuring means for collection a computational tomography volume or a magnetic resonance volume, for a human patient, and
a computer system adapted to perform the steps of a method defined in any of claims 1-27.

30. The system of claim 29, wherein the computer system is adapted to perform the steps of a method defined in any of claims 14-27.
